(19) United States
(12) Patent Application Publication
(10) Pub. No.: US 2014/0146931 A1
(43) Pub. Date: May 29, 2014

(54) SYNCHRONIZATION CONTROL APPARATUS, ARITHMETIC PROCESSING DEVICE, PARALLEL COMPUTER SYSTEM, AND CONTROL METHOD OF SYNCHRONIZATION CONTROL APPARATUS

(71) Applicant: Fujitsu Limited, Kawasaki-shi (JP)

(72) Inventor: Shigekatsu SAGI, Kawasaki (JP)

(73) Assignee: Fujitsu Limited, Kawasaki-shi (JP)

(21) Appl. No.: 14/168,805

(22) Filed: Jan. 30, 2014

Related U.S. Application Data
(63) Continuation of application No. PCT/JP2011/067803, filed on Aug. 3, 2011.

(51) Int. Cl. H04L 7/00

(52) U.S. Cl. CPC H04L 7/0087
USPC 375/362

(57) ABSTRACT

A synchronization control apparatus is included in an arithmetic processing device. The arithmetic processing device is connected to another arithmetic processing device via a data transfer device. The synchronization control apparatus is connected to a clock divider which divides an input clock signal into N. In the synchronization control apparatus: a detecting unit detects the rising or the falling of a divided clock signal; a monitoring unit monitors the elapsed time since the rising or the falling of the divided clock signal; a clock generating unit generates a control clock by multiplying the divided clock signal by N; a synchronization request receiving unit receives a synchronization request from the other arithmetic processing device; a clock control unit outputs the control clock; a synchronization request sending unit sends a synchronization request to the other arithmetic processing device via the data transfer device.

### CROSS-REFERENCE TO RELATED APPLICATION(S)

This application is a continuation of International Application No. PCT/JP2011/067803, filed on Aug. 3, 2011, the entire contents of which are incorporated herein by reference.

### FIELD

The embodiments discussed herein are related to a synchronization control apparatus, an arithmetic processing unit, a parallel computer system, and a control method of the synchronization control apparatus.

### BACKGROUND

A conventional parallel computer system that has multiple central processing units (CPUs) is known. An example of the parallel computer system includes a technology that synchronizes processes performed by CPUs by making values stored in System TICK registers (hereinafter, referred to as STICK registers) in the CPUs the same.

FIG. 21 is a schematic diagram illustrating an example of a conventional parallel computer system. In the example illustrated in FIG. 21, a parallel computer system 70 includes an oscillator 71, a reference signal generating unit 72, multiple CPUs 73 to 73e, multiple crossbar chips (hereinafter, referred to as XBs) 74 to 74b, and a bus 75.

The CPU 73 includes cores 76 and 79 and includes, inside the cores 76 and 79, STICK registers 77 and 80, respectively, that are used to execute processes in synchronization with the other CPUs 73a to 73e. Furthermore, the CPU includes a synchronization control mechanism 90 that synchronizes values stored in the STICK registers with STICK registers in the other CPUs. It is assumed that the CPUs 73a to 73e execute the same functions executed by the CPU 73; therefore, descriptions thereof will be omitted.

The reference signal generating unit 72 included in a parallel computer system 1 generates, in accordance with a signal input from the oscillator 71, a reference signal that counts values stored in the STICK registers 77 to 77e and 80 to 80e in the CPUs 73 to 73e, respectively. Then, via a transmission path in which signal transmission characteristics, such as the length of connection lines, are managed, the reference signal generating unit 72 supplies the generated reference signal to each of the CPUs 73 to 73e with the minimum skew. Specifically, the reference signal generating unit 72 supplies, to each of the CPUs 73 to 73e, the reference signal with the same phase.

FIG. 22 is a schematic diagram illustrating a conventional CPU. As illustrated in FIG. 22, the CPU 73 includes the core 76, the core 79, and the synchronization control mechanism 90. The core 76 includes the STICK register 77 and an instruction control unit (IU) 78. The core 79 includes the STICK register 80 and an IU 81. The CPU 73, which has this configuration, supplies, to the synchronization control mechanism 90 via the path illustrated by (A) in FIG. 22, the reference signal supplied from the reference signal generating unit 72.

Furthermore, if active software requests synchronization of processes executed by the CPUs 73 to 73e, the IUs 78 and 81 request, as illustrated by (B) in FIG. 22, the synchronization control mechanism 90 to synchronize the processes executed by the CPUs 73 to 73e. In such a case, as illustrated at (C′) in FIG. 22, the synchronization control mechanism 90 broadcasts a synchronization request, which indicates that the counting of a STICK register is to be started or to be stopped, to the synchronization control mechanisms 90 to 90e, including the synchronization control mechanisms 90 itself, in the CPUs 73 to 73e, respectively.

In this example, each of the CPUs 73 to 73e, each of the XBs 74 to 74b, and the bus 75 are connected by a parallel bus in which signal transmission characteristics are managed and a constant latency is expected. Consequently, as illustrated by (C) in FIG. 22, each of the synchronization control mechanisms 90 to 90e receives, at the same timing, the synchronization request that was broadcast. Then, as illustrated by (D) in FIG. 22, on the basis of the timing at which the synchronization request was received, the synchronization control mechanism 90 starts or stops the counting of the values stored in the STICK registers 77 and 80.

By executing the process described above, each of the synchronization control mechanisms 90 to 90e starts counting the values in each of the STICK registers 77 to 77e and 80 to 80e at the same timing and synchronizes the processes executed by the CPUs 73 to 73e.

In the following, an example of each of the synchronization control mechanisms 90 to 90e will be described with reference to the drawings. FIG. 23 is a schematic diagram illustrating a conventional synchronization control mechanism. For example, the synchronization control mechanism 90 includes a synchronizer 91, a rising edge detector 92, a phase counter 93, a setting register 94a, a comparator 94b, a setting register 95a, a comparator 95b, a control packet sending unit 96, and a control packet receiving unit 97. The control packet sending unit 96 includes a sending buffer 96a, an output circuit 96b, and an encoder 96c. The control packet receiving unit 97 includes a decoder 97a, a receiving buffer 97b, and an update circuit 97c. Paths illustrated by (A) to (D) in FIG. 23 correspond to paths illustrated by (A) to (D) in FIG. 22, respectively.

The synchronizer 91 synchronizes the reference signal, which was received via the path illustrated by (A) in FIG. 23, with a core clock of the core. The rising edge detector 92 detects the rising edge of the reference signal that was synchronized with the core clock. The phase counter 93 counts the number of cycles of the core clock. Every time the rising edge detector 92 detects the rising edge, the phase counter 93 resets the number of cycles of the counted core clock. Specifically, the phase counter 93 measures, by using the core clock, the elapsed time since the rising edge of the reference signal.

At this point, a predetermined value is set, in advance, in the setting register 94a and the setting register 95a. When the value of the phase counter 93 becomes the same as that set in the setting register 94a, the comparator 94b outputs an enable signal to the output circuit 96b. Furthermore, when the value of the phase counter 93 becomes the same as that set in the setting register 95a, the comparator 95b outputs an enable signal to the update circuit 97c.

Specifically, if the time period that is set in the setting register 94a has elapsed since the rising edge of the reference signal, the comparator 94b outputs an enable signal to the output circuit 96b. Furthermore, if the time period that is set in the setting register 95a has elapsed since the rising edge of the reference signal, the comparator 95b outputs an enable signal to the update circuit 97c. In the description below, the timing at which the comparator 94b sends an enable signal is referred to as the “XBC Timing” and the timing at which the comparator 95b outputs an enable signal is referred to as the “REG-WR Timing”.

When the control packet sending unit 96 receives a synchronization request from the IU 78 via the path illustrated by (B) in FIG. 23, the control packet sending unit 96 stores the received synchronization request in the sending buffer 96a. Then, when an enable signal is input to the output circuit 96b, i.e., when the time period measured by the phase counter 93 reaches the “XBC Timing”, the control packet sending unit 96 executes the following process. Namely, the control packet sending unit 96 packetizes the synchronization request by using the encoder 96c and then broadcasts the packetized synchronization request via the XB 74 using the path illustrated by (C′) illustrated in FIG. 23.

In contrast, when the control packet receiving unit 97 receives, via the path illustrated by (C) in FIG. 23, a packet in which the synchronization request is stored, the control packet receiving unit 97 decodes the packet by using the decoder 97a and stores the synchronization request in the receiving buffer 97b. When an enable signal is input, i.e., when the time measured by the phase counter 93 reaches the “REG-WR Timing”, the update circuit 97c executes the following process.

Namely, when the synchronization request stored in the receiving buffer 97b indicates the starting of the count executed by each CPU, the update circuit 97c stores “0” in a control register 98. Consequently, the synchronization control mechanism 90 outputs, via the path illustrated by (D) in FIG. 23, the reference signal to the STICK register 77 and then starts the count of the STICK register 77. Specifically, immediately after the synchronization control mechanism 90 receives the synchronization request, the synchronization control mechanism 90 starts to count the STICK register when a phase counter 93 indicates the “REG-WR Timing”.

FIG. 24 is a timing chart illustrating the timing at which counting of a STICK register is started. FIG. 24 illustrates the reference signal that is received via the path illustrated by (A) in FIG. 23, the synchronization request that is received via the path illustrated by (B) in FIG. 23, the packet that is received via the path illustrated by (C) in FIG. 23, and the reference signal that is output via the path illustrated by (D) in FIG. 23. Furthermore, FIG. 24 illustrates the timing at which each of the CPUs 73 to 73e receives the packet and the timing at which each of the CPUs 73 to 73e counts the STICK register. First, as illustrated at (E) in FIG. 24, when the synchronization control mechanism 90 receives a synchronization request from the IU 78, the synchronization control mechanism 90 broadcasts the packet in which the synchronization request is stored to each of the CPUs 73 to 73e at the “XBC Timing” illustrated at (F) in FIG. 24.

Then, because each of the CPUs 73 to 73e, each of the XBs 74 to 74b, and the bus 75 are connected via the parallel bus in which the latency is guaranteed, each of the CPUs 73 to 73e receives, at the same timing as illustrated at (H) in FIG. 24, the packet in which the synchronization request is stored. Thereafter, each of the synchronization control mechanisms 90 to 90e starts the counting of the corresponding STICK register at the “REG-WR Timing” illustrated at (G) in FIG. 24. With respect to the conventional technology, refer to Japanese Laid-open Patent Publication No. 10-233766, and Japanese Laid-open Patent Publication No. 10-243483, for example.

However, with the technology that broadcasts a synchronization request described above, there is a problem in that synchronization control is not appropriately performed when, instead of a parallel bus in which a control signal is separated from data, which is in the control signal and is targeted for control, each CPU is connected by way of a method in which transmission latency is not constant, such as a serial link that transmits both a control signal and data by using a single signal line.

FIG. 25 is a schematic diagram illustrating a case in which, when the transmission latency of each CPU varies, the timing of the counting of a STICK register varies among CPUs. In the example illustrated in FIG. 25, each of the CPUs 73 to 73a is connected via a serial link. Furthermore, similarly to (E) illustrated in FIG. 24, the symbol (E) illustrated in FIG. 25 indicates the timing at which a synchronization request is received from the IU 78. Similarly to (F) illustrated in FIG. 24, the symbol (F) illustrated in FIG. 25 indicates the “XBC Timing”. Similarly to (G) illustrated in FIG. 24, the symbol (G) illustrated in FIG. 25 indicates the “REG-WR Timing”. Furthermore, similarly to FIG. 24, FIG. 25 illustrates the timing at which each of the CPUs 73 to 73e receives a packet and the timing at which each of the CPUs 73 to 73e counts the STICK register.

For example, as illustrated at (E) in FIG. 25, if the IU 78 issues a synchronization request, a CPU 73 broadcasts a synchronization request to each of the CPUs 73 to 73e at the “XBC Timing” illustrated at (F) in FIG. 25. At this point, in a serial link, by allowing the occurrence of a transmission error at a certain rate, the throughput of the CPUs 73 to 73e is made to be higher than that when the occurrence of a transmission error is not allowed. Specifically, in a serial link that allows a transmission error at a certain rate, if a transmission error occurs, because the transmission error is retrieved by resending data, the transmission latency increases when compared with a case in which a transmission error is not allowed. Consequently, unlike signal transmission in which the occurrence of a transmission error is not allowed, in the signal transmission using a serial link, the transmission latency is not constant.

Consequently, as illustrated at (I) in FIG. 25, if a transmission error occurs in each of the CPUs 73a, 73b, and 73e, each of the CPUs 73 to 73e receives the broadcast synchronization request at a different timing. Thus, a CPU that starts counting a STICK register at the “REG-WR Timing” illustrated at (G) in FIG. 25 and a CPU that starts counting a STICK register at the “REG-WR Timing” illustrated at (J) in FIG. 25 are present in a mixed manner. In the example illustrated in FIG. 25, the CPU 73a and the CPU 73b start counting at a different timing to the other CPUs 73 and 73c to 73e. Specifically, there are some CPUs, in a mixed manner, that each start counting a STICK register at a different timing.

Consequently, because the CPUs 73 to 73e are not able to match the values stored in the STICK registers 77 to 77e and 80 to 80e, respectively, there is a problem in that processes are not synchronously executed.

### SUMMARY

According to an aspect of an embodiment, a synchronization control apparatus is connected to a clock divider, which divides an input clock signal into N. The synchronization control apparatus is included in an arithmetic processing device that is connected to another arithmetic processing device via a data transfer device. The synchronization control apparatus includes a detecting unit, a monitoring unit, a clock generating unit, a synchronization request receiving unit, a clock control unit, and a synchronization request sending unit. The detecting unit detects the rising or the falling of a divided clock signal that is divided by the clock divider. The monitoring unit monitors, by monitoring the elapsed time since the rising or the falling of the divided clock signal detected by the detecting unit, a first timing at which a synchronization request is sent to the data transfer device and a second timing at which a synchronization register included in the arithmetic processing device is updated. The clock generating unit generates a control clock by multiplying the divided clock signal, which is divided by the clock divider, by N. The synchronization request receiving unit receives, via the data transfer device, a synchronization request sent from the other arithmetic processing device. The clock control unit outputs, when the synchronization request receiving unit receives the synchronization request sent from the other arithmetic processing device and when the monitoring unit detects the second timing, the control clock generated by the clock generating unit. The synchronization request sending unit sends, when the monitoring unit detects the first timing, a synchronization request to the other arithmetic processing device via the data transfer device.

According to another aspect of an embodiment, an arithmetic processing device is connected to another arithmetic processing device via a data transfer device. The arithmetic processing device includes an arithmetic processing unit, and a synchronization control apparatus. The arithmetic processing unit executes arithmetic processing. The synchronization control apparatus receives an input of a divided clock signal, which is generated by a clock divider by dividing an input clock signal into N, and that executes synchronization control between the arithmetic processing device and the other arithmetic processing device. The synchronization control apparatus includes a detecting unit, a monitoring unit, a clock generating unit, a synchronization request receiving unit, a clock control unit, and a synchronization request sending unit. The detecting unit detects the rising or the falling of the divided clock signal to be input. The monitoring unit monitors, by monitoring the elapsed time since the rising or the falling of the divided clock signal detected by the detecting unit, a first timing at which a synchronization request is sent and a second timing at which a synchronization register included in the arithmetic processing device is updated. The clock generating unit generates a control clock by multiplying the divided clock signal, which is divided by the clock divider, by N. The synchronization request receiving unit receives, via the data transfer device, a synchronization request sent from the other arithmetic processing device. The clock control unit, when the synchronization request receiving unit receives the synchronization request from the other arithmetic processing device and when the monitoring unit detects the second timing, updates the synchronization register and outputs the control clock generated by the clock generating unit to the arithmetic processing unit. The synchronization request sending unit sends, when the monitoring unit detects the first timing, a synchronization request to the other arithmetic processing device via the data transfer device.

According to still another aspect of an embodiment, a parallel computer system includes a clock divider and multiple arithmetic processing devices. The clock divider divides an input clock signal into N. The multiple arithmetic processing devices are each connected to one of the arithmetic processing devices via a data transfer device. Each of the arithmetic processing devices includes a synchronization control apparatus that executes a process in synchronization with the arithmetic processing devices. The synchronization control apparatus includes a detecting unit, a monitoring unit, a clock generating unit, a synchronization request receiving unit, a clock control unit, and a synchronization request sending unit. The detecting unit detects the rising or the falling of a divided clock signal that is divided by the clock divider. The monitoring unit monitors, by monitoring the elapsed time since the rising or the falling of the divided clock signal detected by the detecting unit, a first timing at which a synchronization request is sent to the data transfer device and a second timing at which a synchronization register included in each of the arithmetic processing devices is updated. The clock generating unit generates a control clock by multiplying the divided clock signal, which is divided by the clock divider, by N. The synchronization request receiving unit receives, via the data transfer device, a synchronization request sent from the one of the arithmetic processing devices. The clock control unit outputs, when the synchronization request receiving unit receives the synchronization request sent from the one of the arithmetic processing devices and when the monitoring unit detects the second timing, the control clock generated by the clock generating unit. The synchronization request sending unit sends, when the monitoring unit detects the first timing, the synchronization request to the arithmetic processing devices via the data transfer device.

According to still another aspect of an embodiment, a control method is executed by a synchronization control apparatus that is connected to a clock divider, which divides an input clock signal into N, and that is included in an arithmetic processing device that is connected to another arithmetic processing device via a data transfer device. The control method includes: detecting the rising or the falling of a divided clock signal divided by the clock divider; monitoring, by monitoring the elapsed time since the rising or the falling of the divided clock signal detected at the detecting, a first timing at which a synchronization request is sent to the data transfer device and a second timing at which a synchronization register included in the arithmetic processing device is updated; generating a control clock by multiplying the divided clock signal by N; receiving, via the data transfer device, a synchronization request sent from the other arithmetic processing device; outputting, when the synchronization request sent from the other arithmetic processing device is received and when the second timing is detected, the control clock generated at the generating; and sending, via the data transfer device, the synchronization request to the other arithmetic processing device when the first timing is detected.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating an example of a parallel computer system according to a first embodiment;

FIG. 2 is a schematic diagram illustrating an example of a CPU according to the first embodiment;

FIG. 3 is a schematic diagram illustrating an example of a synchronization control mechanism according to the first embodiment;

FIG. 4 is a schematic diagram illustrating an example of a control packet that stores therein a synchronization request;

FIG. 5A is a schematic diagram illustrating an example of the synchronization control mechanism according to the first embodiment;

FIG. 5B is a schematic diagram (1) illustrating an example of an operation of the synchronization control mechanism;

FIG. 5C is a schematic diagram (2) illustrating an example of an operation of the synchronization control mechanism;

FIG. 5D is a schematic diagram (3) illustrating an example of an operation of the synchronization control mechanism;

FIG. 6 is a timing chart illustrating the timing at which counting of a STICK register according to the first embodiment is started;

FIG. 7 is a schematic diagram illustrating an example of a parallel computer system according to a second embodiment;

FIG. 8 is a schematic diagram illustrating an example of a CPU according to the second embodiment;

FIG. 9 is a schematic diagram illustrating a synchronization control mechanism according to the second embodiment;

FIG. 10 is a schematic diagram illustrating an example of the synchronization control mechanism according to the second embodiment;

FIG. 11 is a timing chart illustrating the timing at which counting of a STICK register according to the second embodiment is started;

FIG. 12 is a schematic diagram illustrating an example of a parallel computer system according to a third embodiment;

FIG. 13 is a schematic diagram illustrating a part of the parallel computer system according to the third embodiment;

FIG. 14 is a schematic diagram illustrating an example of components according to the third embodiment;

FIG. 15 is a schematic diagram illustrating a synchronization control mechanism according to the third embodiment;

FIG. 16 is a schematic diagram illustrating a BC pipeline mechanism according to the third embodiment;

FIG. 17 is a schematic diagram illustrating an example of the BC pipeline mechanism;

FIG. 18 is a timing chart illustrating the timing at which the synchronization control mechanism sends a control packet to the BC pipeline mechanism;

FIG. 19 is a timing chart illustrating the timing at which the BC pipeline mechanism broadcasts the control packet;

FIG. 20 is a timing chart illustrating the timing at which the synchronization control mechanism outputs a synchronization signal to a STICK register;

FIG. 21 is a schematic diagram illustrating an example of a conventional parallel computer system;

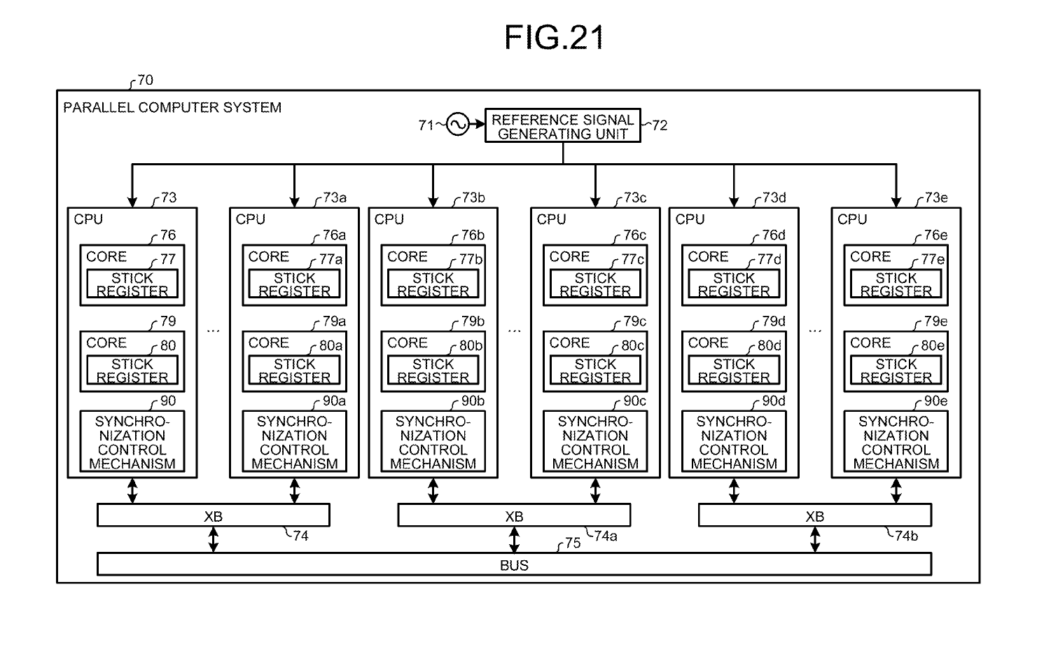

FIG. 22 is a schematic diagram illustrating a conventional CPU;

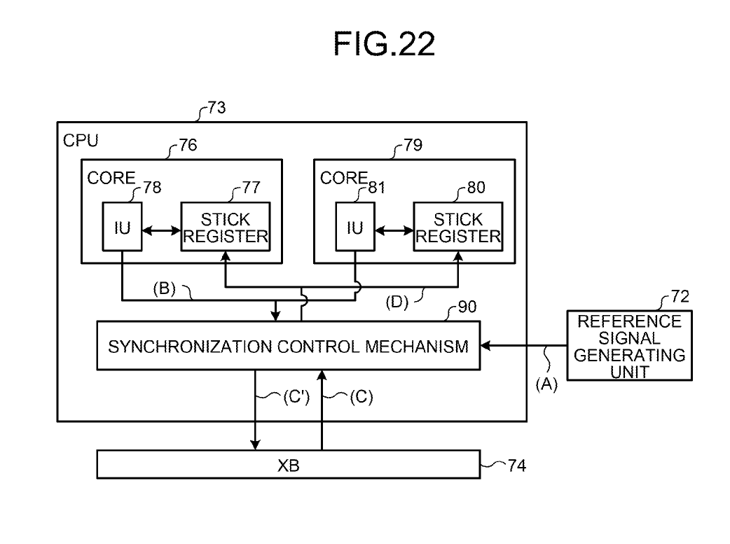

FIG. 23 is a schematic diagram illustrating a conventional synchronization control mechanism;

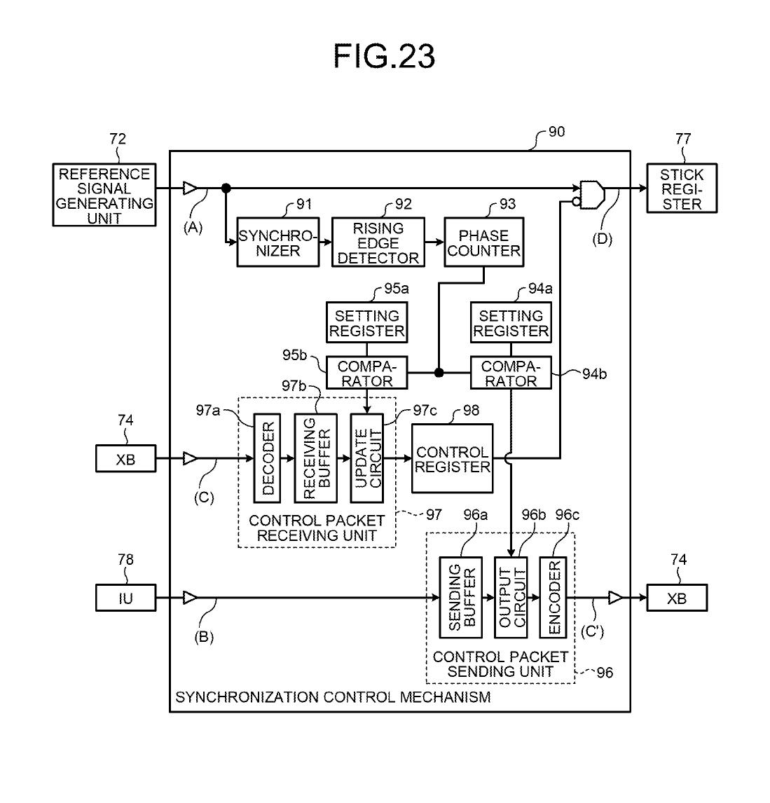

FIG. 24 is a timing chart illustrating the timing at which counting of a STICK register is started; and

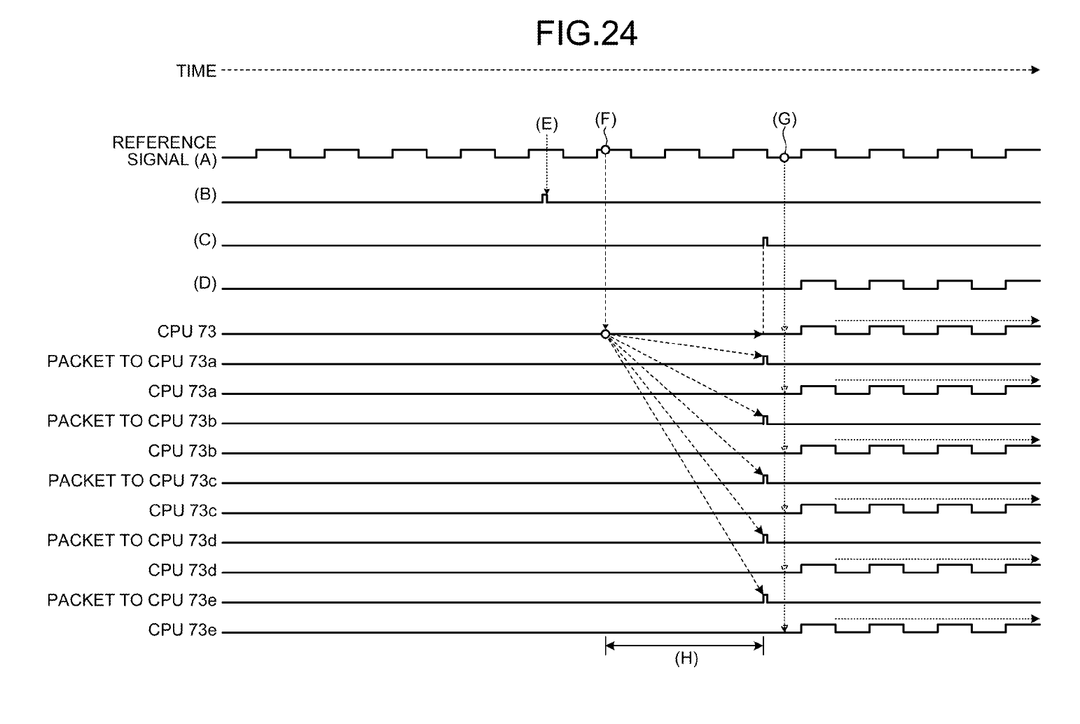

FIG. 25 is a schematic diagram illustrating a case in which, when the transmission latency of each CPU varies, the timing of counting of a STICK register varies among CPUs.

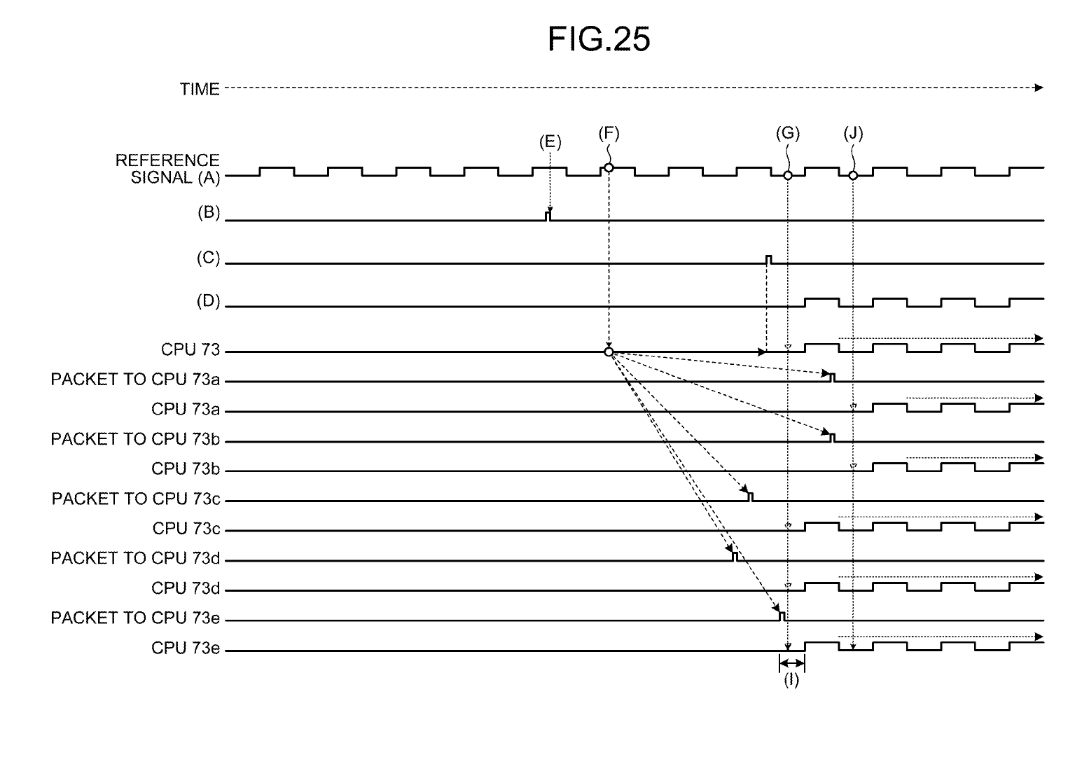

### DESCRIPTION OF EMBODIMENTS

Preferred embodiments of the present invention will be explained with reference to accompanying drawings.

### [a] First Embodiment

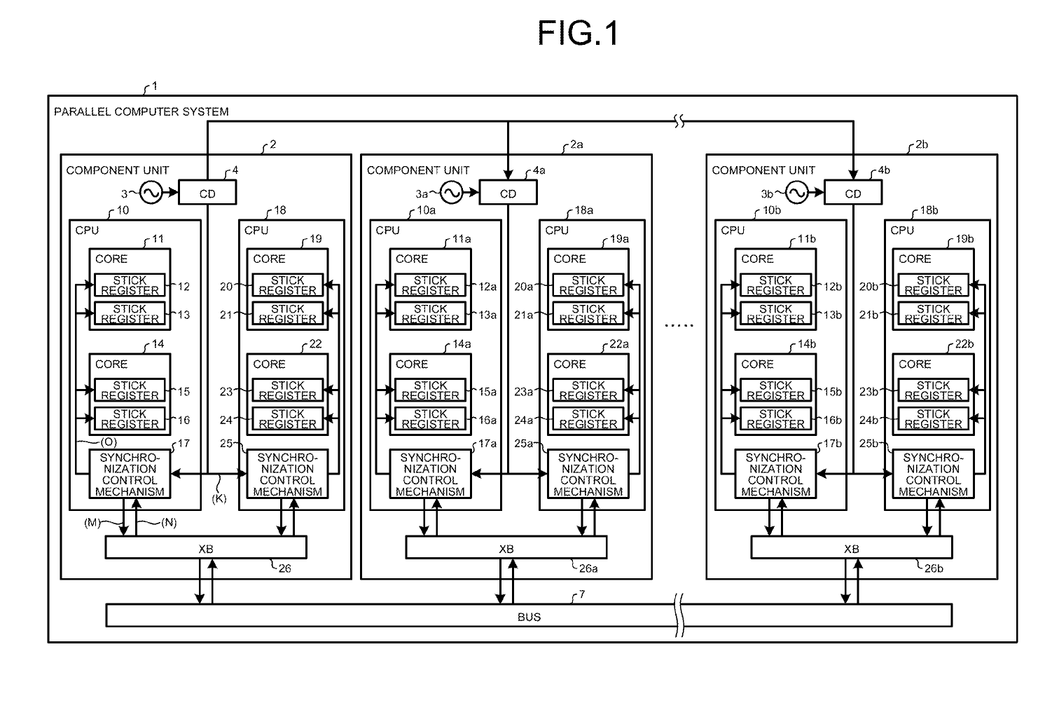

In a first embodiment, an example of a parallel computer system will be described with reference to FIG. 1. FIG. 1 is a schematic diagram illustrating an example of a parallel computer system according to a first embodiment. As illustrated in FIG. 1, the parallel computer system 1 includes multiple component units 2 to 2b and a bus 7.

The component unit 2 includes an oscillator 3, a clock distributor (CD) 4, a CPU 10, a CPU 18, and an XB 26. Similarly to the component unit 2, the component units 2a and 2b include oscillators 3a and 3b, CDs 4a and 4b, CPUs 10a and 10b, CPUs 18a and 18b, XBs 26a and 26b, respectively. The bus 7 is a connection path, such as an interconnect network, that is shared by each of the units in the parallel computer system 1. Furthermore, each of the CPUs 10 to 10b, CPUs 18 to 18b, XBs 26 to 26b, and the bus 7 are connected by a serial link.

The CPU 10 (10a, 10b) includes a core 11 (11a, 11b), a core 14 (14a, 14b), and a synchronization control mechanism 17 (17a, 17b). The core 11 (11a, 11b) includes STICK registers 12 and 13 (12a and 13a, 12b and 13b) for each strand. Similarly, the core 14 (14a, 14b) also includes STICK registers 15 and 16 (15a and 16a, 15b and 16b) for each strand. The CPU 18 (18a, 18b) includes a core 19 (19a, 19b), a core 22 (22a, 22b), and a synchronization control mechanism 25 (25a, 25b). The core 19 (19a, 19b) includes STICK registers 20 and 21 (20a and 21a, 20b and 21b). The core 22 (22a, 22b) includes STICK registers 23 and 24 (23a and 24a, 23b and 24b).

In the description below, it is assumed that the CPUs 10a and 10b and the CPUs 18 to 18b execute the same process as that executed by the CPU 10; therefore, descriptions thereof will be omitted. Furthermore, it is assumed that the XBs 26a and 26b execute the same process as that executed by the XB 26; therefore, descriptions thereof will be omitted.

In the following, processes executed by the oscillator 3, the CD 4, the CPU 10, and the XB 26 in the component unit 2 will be described. The CDs 4 to 4b are clock devices that supply divided signals that have the same phase and the same frequency to the CPUs 10 to 10b and 18 to 18b, respectively. Specifically, the CDs 4 to 4b are connected to the oscillators 3 to 3b, respectively, that generate reference signals that have the same frequency. Furthermore, each of the CDs 4 to 4b are connected with each other via a transmission path in which signal transmission characteristics, such as the length of connection lines, are managed. One of the CDs is used as the master CD that sends a reference signal to the other CDs.

For example, when the CD 4 is connected, as the master CD, to the other CDs 4a and 4b, the CD 4 acquires a reference signal generated by the oscillator 3 and then divides the acquired reference signal into divided signals with a frequency of 1/N (N is greater than 1). Then, the CD 4 supplies, to the other CDs 4a and 4b, the divided signals with minimum skew. Furthermore, at the timing at which the latency of the divided signals that were sent to the other CDs 4a and 4b is taken into consideration, the CD 4 sends the divided signals to the synchronization control mechanism 17 in the CPU 10 and to the synchronization control mechanism 25 in the CPU 18.

In contrast, when the CD 4a receives the divided signals from the CD 4, the CD 4a supplies the received signals to a synchronization control mechanism 17a in the CPU 10a and to the synchronization control mechanism 25a in the CPU 18a. Similarly, when the CD 4b receives the divided signals from the CD 4, the CD 4b also supplies the received signals to synchronization control mechanisms 17b and 25b. Each of the CDs 4 to 4b may also operate as the master. An arbitrary CD may be used as the master CD depending on the configuration of the parallel computer system 1.

An arbitrary dividing method may be used for the method that the CDs 4 to 4b used to divide a reference signal. For example, the CDs 4 to 4b may also divide, by using a frequency divider, such as a synchronization counter, a reference signal and generate the divided reference signals, i.e., the divided signals. As described above, the CDs 4 to 4b supply the divided signals with cycles the number of which is N times as much as that of the reference signal to the synchronization control mechanisms 17 to 17b and 25 to 25b, respectively, while adjusting the divided signals such that the signals maintain the same phase.

The CPU 10 is an arithmetic processing unit that executes the process allocated to the CPU 10. Furthermore, the CPU 10 synchronizes the values stored in the STICK registers 12, 13, 15, and 16 with the values stored in the STICK registers in the other CPUs, respectively. Then, by executing the process in accordance with the values stored in the STICK registers 12, 13, 15, and 16, the CPU 10 executes the process in synchronization with the CPUs 10a, 10b, and 18 to 18b.

The synchronization control mechanism 17 receives the divided signals from the CD 4 via the path illustrated by (K) in FIG. 1. Furthermore, the synchronization control mechanism 17 generates a control signal by multiplying a received divided signal by N and then monitors the elapsed time since the rising or the falling of the divided signal. Furthermore, when an application executed by the CPU 10 issues a synchronization request that requests synchronization with the processes executed by the other CPUs 10a, 10b, and 18 to 18b, the synchronization control mechanism 17 executes the following process.

Namely, the synchronization control mechanism 17 broadcasts a control packet, in which the synchronization request is stored, to each of the CPUs 10 to 10b and 18 to 18b, including the CPU 10 that includes the synchronization control mechanism 17 itself, via the path illustrated by (M) in FIG. 1. Furthermore, when the synchronization control mechanism 17 receives a control packet in which the synchronization request is stored via the path illustrated by (N) in FIG. 1, the synchronization control mechanism 17 executes the following process. Namely, in accordance with the timing indicated by the divided signal received from the CD 4, the synchronization control mechanism 17 supplies a control signal to each of the STICK registers 12, 13, 15, and 16 via the path illustrated by (O) in FIG. 1.

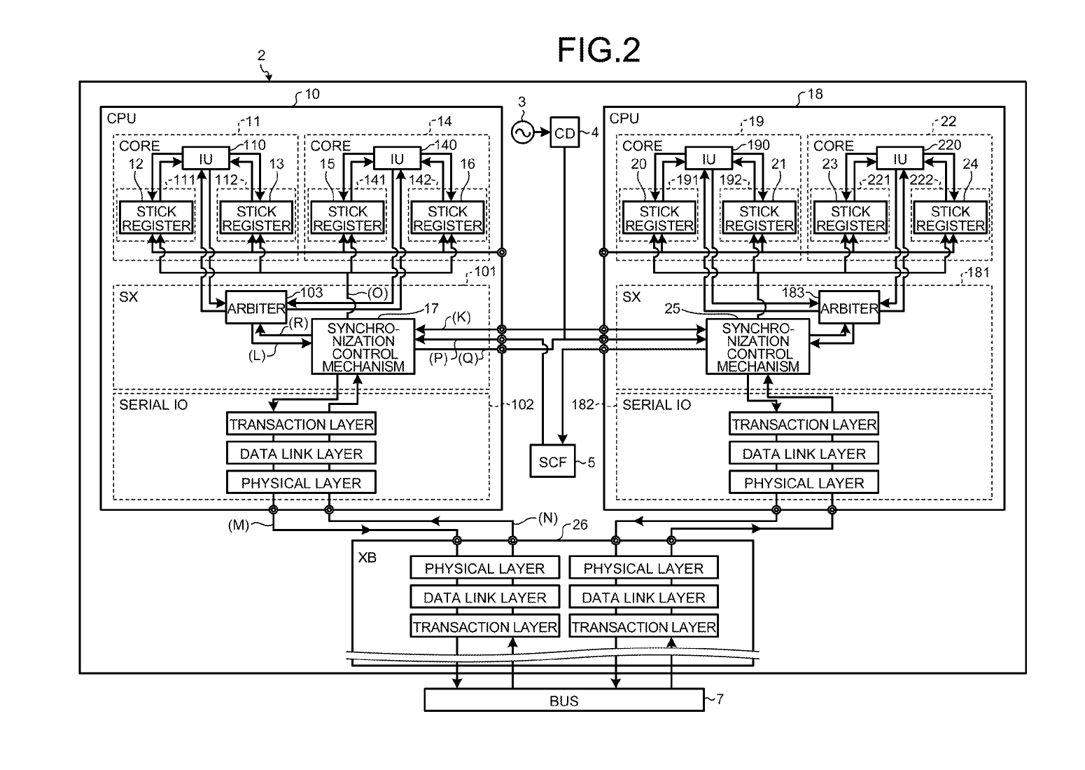

In the following, the process executed by the CPU 10 will be described in detail. FIG. 2 is a schematic diagram illustrating an example of a CPU according to the first embodiment. The paths illustrated by (K), (M), (N), and (O) in FIG. 2 correspond to the paths illustrated by (K), (M), (N), and (O), respectively, in FIG. 1. Furthermore, in the example illustrated in FIG. 2, it is assumed that the component unit 2 includes a system control facility (SCF) 5 that is a system control unit that controls communication between the CPUs 10 and 18.

In the example illustrated in FIG. 2, the CPU 10 includes the core 11, the core 14, a secondary cache and external access unit (SX) 101 that is an external connecting unit, and a serial input and output (IO) unit 102. The core 11 includes an instruction control unit (IU) 110, the STICK register 12 in a strand T 111, and the STICK register 13 in a strand T 112. Furthermore, the serial IO unit 102 is an input-output device that sends and receives data with the XB 26 via the transaction layer, the data link layer, and the physical layer by using a serial link.

Similarly, the core 14 also includes an IU 140, the STICK register 15 in a strand T 141, and the STICK register 16 in a strand T 142. The SX 101 includes an arbiter 103 and the synchronization control mechanism 17. In a description below, it is assumed that the core 14 executes the same process as that executed by the core 11; therefore, a description thereof in detail will be omitted.

When the IU 110 receives, from the arbiter 103, a read request with respect to the STICK register 12 or the STICK register 13, the IU 110 reads a value stored in the STICK register 12 or the STICK register 13. Then, the IU 110 sends the read value to the arbiter 103. Furthermore, when the IU 110 receives, from the arbiter 103, a write request with respect to a register together with a value that is to be written, the IU 110 writes the received value to the STICK register 12 or to the STICK register 13.

When the program executed by the CPU 10 requests the reading of the value stored in the STICK register 12 or the STICK register 13, the arbiter 103 sends, to the IU 110, a read request with respect to the register. Furthermore, when the program executed by the CPU 10 requests an update of the value stored in the STICK register 12 or the STICK register 13, the arbiter 103 sends, to the IU 110, a write request with respect to the register together with a value that is to be read.

The arbiter 103 also sends, to the IU 140 in a similar manner, a write request or a read request with respect to the STICK register 15 or 16. Furthermore, when the program executed by the CPU 10 requests a process to be executed by each of the CPUs 10 to 10b and 18 to 18b, the arbiter 103 issues a synchronization request and then sends the request to the synchronization control mechanism 17 via the path illustrated by (L) in FIG. 2.

The synchronization control mechanism 17 receives, from the CD 4 via the path illustrated by (K) in FIG. 2, the divided signals obtained by dividing the reference signal into 1/N frequencies. Furthermore, the synchronization control mechanism 17 generates a control signal by multiplying the received divided signal by N. The control signal mentioned here is a signal that indicates the timing of counting the value stored in each of the STICK registers 12, 13, 15, and 16. Furthermore, the synchronization control mechanism 17 detects the rising or the falling of the divided signal and monitors the elapsed time since the detected rising or falling of the signal.

When the synchronization control mechanism 17 receives a synchronization request from the arbiter 103 and when the monitored elapsed time reaches the “XBC Timing”, the synchronization control mechanism 17 sends the synchronization request to the serial IO unit 102 via the path illustrated by (M) in FIG. 2. Furthermore, when the synchronization control mechanism 17 receives a synchronization request from the serial IO unit 102 via the path illustrated by (N) in FIG. 2 and when the monitored elapsed time reaches the “REG-WR Timing”, the synchronization control mechanism 17 executes the following process. Namely, by supplying a control signal to each of the STICK registers 12, 13, 15, and 16 via the path illustrated by (O) in FIG. 2, the synchronization control mechanism 17 counts the values stored in the STICK register. Specifically, the control signal is a signal that increments the value stored in each of the STICK registers 12, 13, 15, and 16.

Furthermore, the synchronization control mechanism 17 receives, from the path illustrated by (P) in FIG. 2, setting information that indicates the elapsed time has reached the “SBC Timing” or that indicates the elapsed time has reached the “REG-WR Timing”. In such a case, the synchronization control mechanism 17 sets an elapsed time that has reached the “SBC Timing” or an elapsed time that has reached the “REG-WR Timing” to the elapsed time that is indicated by the received setting information.

Furthermore, the synchronization control mechanism 17 transfers the received setting information to the synchronization control mechanism 25 in the CPU 18 via the path illustrated by (Q) in FIG. 2. Furthermore, the synchronization control mechanism 17 sends, to the arbiter 103 via the path illustrated by (R) in FIG. 2, a signal that indicates whether the control signal is supplied to each of the STICK registers 12, 13, 15, and 16.

Similarly to the CPU 10, the CPU 18 includes the core 19, the core 22, an SX 181, and a serial IO unit 182. The core 19 includes an instruction control unit (IU) 190, the STICK register 20 in a strand T 191, and the STICK register 21 in a strand T 192. Furthermore, the serial IO unit 182 is an input-output device that sends and receives data with the XB 26 via the transaction layer, the data link layer, and the physical layer by using a serial link.

Similarly, the core 22 also includes an IU 220, the STICK register 23 in a strand T 221, and the STICK register 24 in a strand T 222. The SX 181 includes an arbiter 183 and the synchronization control mechanism 25. It is assumed that the core 19, the core 22, the SX 181, and the serial IO unit 182 in the CPU 18 execute the same processes as those executed by the core 11, the core 14, the SX 101, and the serial IO unit 102 in the CPU 10; therefore, descriptions thereof in detail will be omitted.

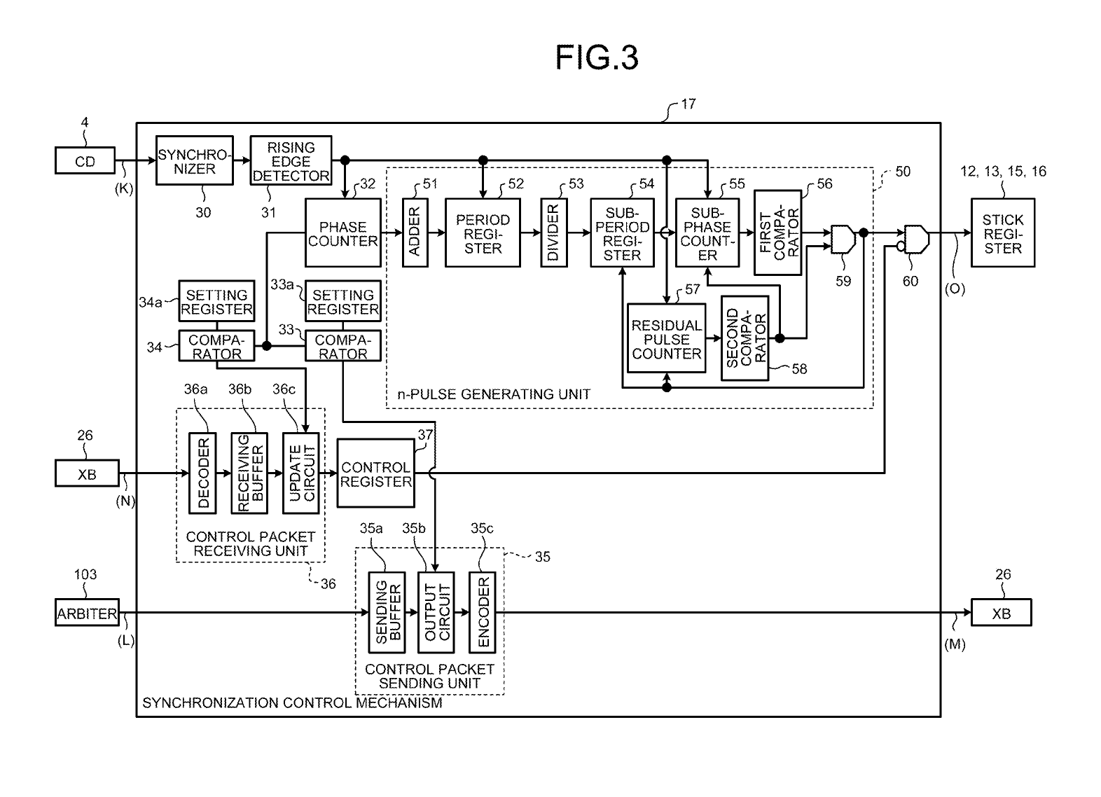

In the following, an example of the synchronization control mechanism 17 will be described with reference to FIG. 3. FIG. 3 is a schematic diagram illustrating an example of the synchronization control mechanism according to the first embodiment. The paths illustrated by (K), (L), (M), (N), and (O) in FIG. 3 correspond to the paths illustrated by (K), (L), (M), (N), and (O) in FIG. 2, respectively.

In the example illustrated FIG. 3, the synchronization control mechanism 17 includes a synchronizer 30, a rising edge detector 31, a phase counter 32, a setting register 33a, a comparator 33, a setting register 34a, a comparator 34, a control packet sending unit 35, and a control packet receiving unit 36. Furthermore, the synchronization control mechanism 17 includes a control register 37, an n-pulse generating unit 50, and an AND gate 60. The control packet sending unit 35 includes a sending buffer 35a, an output circuit 35b, and an encoder 35c. The control packet receiving unit 36 includes a decoder 36a, a receiving buffer 36b, and an update circuit 36c.

The n-pulse generating unit 50 includes an adder 51, a period register 52, a divider 53, a sub-period register 54, a sub-phase counter 55, a first comparator 56, a residual pulse counter 57, a second comparator 58, and an AND gate 59.

For example, when the synchronization control mechanism 17 receives the divided signals generated by the CD 4 via the path illustrated by (K) in FIG. 3, the synchronization control mechanism 17 inputs the received divided signals to the synchronizer 30. The synchronizer 30 synchronizes the phase of the divided signals with the core clock of the CPU 10 and inputs, to the rising edge detector 31, the divided signals that were synchronized with the phase of the core clock.

The rising edge detector 31 detects the rising edge of the divided signals that were input from the synchronizer 30. When the rising edge detector 31 detects the rising edge of the divided signals, the rising edge detector 31 inputs a pulse signal to the phase counter 32, the period register 52, the sub-phase counter 55, and the residual pulse counter 57.

In the example illustrated in FIG. 3, instead of using the rising edge detector 31, a falling edge detector that detects the falling edge of a divided signal may also be used. When the falling edge detector detects the falling edge of a divided signal, the falling edge detector inputs a pulse signal to the phase counter 32, the period register 52, the sub-phase counter 55, and the residual pulse counter 57.

The phase counter 32 monitors a core clock in the CPU 10 and counts the number of cycles of the core clock. Furthermore, every time the rising edge detector 31 detects the rising edge of a divided signal, the phase counter 32 resets the number of the counted cycles of the core clock to “0”. Specifically, by measuring the number of cycles of the core clock since the rising edge of the divided signal has been detected, the phase counter 32 measures the elapsed time since the rising edge of the divided signal is detected.

The setting register 33a is a register that is used to set the “XBC Timing”. Specifically, the setting register 33a stores therein a value that indicates, in cycle units of the core clock, the time period between the rising edge of a divided signal and the “XBC Timing”. For example, if the time period corresponding to “5” cycles of the core clock has elapsed since the rising edge of the divided signal is used as the “XBC Timing”, the setting register 33a stores therein the value of “5”.

The comparator 33 compares the number of cycles of the core clock counted by the phase counter 32 with the value stored in the setting register 33a. When the number of cycles of the core clock counted by the phase counter 32 matches the value stored in the setting register 33a, the comparator 33 sends an enable signal to the output circuit 35b in the control packet sending unit 35. Specifically, if it is determined by using the phase counter 32 that a predetermined time period has elapsed since the rising edge of a divided signal, the comparator 33 determines that the time is the “XBC Timing” and then outputs the enable signal to the output circuit 35b.

The setting register 34a is a register that is used to set the “REG-WR Timing”. Specifically, similarly to the setting register 33a, the setting register 34a stores therein a value that indicates, in cycle units of the core clock, the time period between the rising edge of a divided signal and the “REG-WR Timing”. Furthermore, similarly to the comparator 33, the comparator 34 compares the number of cycles of the core clock counted by the phase counter 32 with the value stored in the setting register 34a.

When the number of cycles of the core clock counted by the phase counter 32 matches the value stored in the setting register 34a, the comparator 33 outputs an enable signal to the update circuit 36c in the control packet receiving unit 36. Specifically, if it is determined by using the phase counter 32 that a predetermined time period has elapsed since the rising edge of a divided signal, the comparator 34 determines that the time is the “REG-WR Timing” and then outputs an enable signal to the update circuit 36c.

Furthermore, when the synchronization control mechanism 17 receives a synchronization request issued by the application from the arbiter 103 via the path illustrated by (L) in FIG. 3, the synchronization control mechanism 17 stores the received synchronization request in the sending buffer 35a. At this point, when the application requests a synchronization process to be started by each of the CPUs 10 to 10b and 18 and 18b, the synchronization control mechanism 17 receives, from the arbiter 103, the synchronization request that indicates “0”. In contrast, when the application requests a synchronization process to be stopped by each of the CPUs 10 to 10b and 18 to 18b, the synchronization control mechanism 17 receives, from the arbiter 103, a synchronization request that indicates “1”.

Furthermore, when the output circuit 35b receives an enable signal from the comparator 33, the output circuit 35b sends a synchronization request stored in the sending buffer 35a to the encoder 35c. When the encoder 35c receives the synchronization request from the output circuit 35b, the encoder 35c generates a control packet in which the synchronization request is stored and then sends the generated packet to the XB 26 via the path illustrated by (M) in FIG. 3, whereby the encoder 35c broadcasts the control packet to each of the CPUs 10 to 10b and 18 to 18b. Specifically, if a synchronization request is issued and if the elapsed time reaches the “XBC Timing” since the rising edge of a divided signal, the control packet sending unit 35 broadcasts the control packet in which the synchronization request is stored.

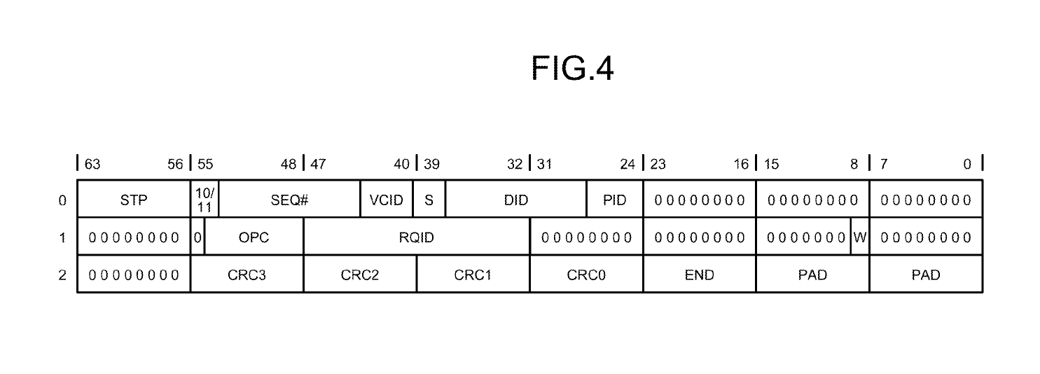

FIG. 4 is a schematic diagram illustrating an example of a control packet that stores therein a synchronization request. As illustrated in FIG. 4, the encoder 35c generates a packet that stores therein a start TLP character (STP), a sequence number (SEQ#), the virtual channel ID (VCID), the packet size (S), and the destination ID (DID). Furthermore, the encoder 35c generates a control packet that stores therein a partition ID (PID), an operation code (OPC), the request ID (RQID), write data (W), multiple cyclic redundancy checks (CRCs) 3 to 0, an end character (END), and a padding character (PAD).

In this example, in STP, a code that indicates the starting of the TLP is stored. In SEQ#, the sequence number of a packet is stored. In VICD, information that indicates the virtual channel ID is stored. In S, the size of a packet is stored. In DID, information that indicates broadcasting or the number of the destination CPU is stored. In PID, the partition ID is stored. In RQID, the request ID is stored. In each CRC, a signal that is used to perform the cyclic redundancy check is stored. In END, a code that indicates the end of the TLP is stored. In PAD, a code that is used to embed the fraction of a packet is stored.

At this point, in W, information on the operation content of STICK is stored. Specifically, when “1” is stored in the area of W in the packet illustrated in FIG. 4, the control packet sending unit 35 requests the stopping of the synchronization of each of the STICK registers 12, 13, 15, and 16. In contrast, when “0” is stored, the control packet sending unit 35 requests the starting of the synchronization of each of the STICK registers 12, 13, 15, and 16.

A description will be given here by referring back to FIG. 3. When the synchronization control mechanism 17 receives, from the XB 26 via the path illustrated by (N) in FIG. 3, the packet that was broadcast by each of the synchronization control mechanisms 17 to 17b and 25 to 25b including the synchronization control mechanism 17 itself, the synchronization control mechanism 17 sends the received packet to the decoder 36a. When the decoder 36a receives the packet, the decoder 36a decodes the received packet and then stores, in the receiving buffer 36b, the synchronization request that is stored in the packet.

When the update circuit 36c receives an enable signal from the comparator 34, the update circuit 36c stores, in the control register 37, the synchronization signal that is stored in the receiving buffer 36b. Specifically, when an application requests the starting of a synchronization process executed by each of the CPUs 10 to 10b and 18 to 18b, the update circuit 36c stores “0” in the control register 37. In contrast, when an application requests the stopping of synchronization process executed by each of the CPUs 10 to 10b and 18 to 18b, the update circuit 36c stores “1” in the control register 37. Specifically, when the control packet receiving unit 36 receives a control packet in which a synchronization request is stored and when the elapsed time since the rising of the divided signal reaches the “REG-WR Timing”, the control packet receiving unit 36 stores the synchronization signal in the control register 37.

At this point, an invert signal of the value stored in the control register 37 is input to the AND gate 60. Consequently, when “0” is set in the control register 37, the AND gate 60 outputs, to the STICK registers 12, 13, 15, 16 via the path illustrated by (O) in FIG. 3, a control signal that is output from the n-pulse generating unit 50, which will be described later. In contrast, when “1” is input to the control register 37, the AND gate 60 stops an output of the control signal. Consequently, the synchronization control mechanism 17 can output or stop the control signal at the timing at which the synchronization control mechanism 17 receives a control packet in which a synchronization request is stored and when the elapsed time since the rising of a divided signal reaches the “REG-WR Timing”.

In the following, each of the units 51 to 59 included in the n-pulse generating unit 50 will be described. The adder 51 calculates a value by adding 1 to the number of cycles of the core clock counted by the phase counter 32 and then sends the calculated value to the period register 52. Specifically, the adder 51 sends, to the period register 52, the value in which phases of the divided signals are indicated by the number of cycles of the core clock.

The period register 52 retains the value sent from the adder 51 when a pulse signal that has been sent from the rising edge detector 31 is received. At this point, when the rising edge detector 31 detects the rising of the divided signal, the rising edge detector 31 sends a pulse signal to the period register 52. Consequently, the period register 52 retains the value in which the cycle of the divided signals is indicated by the number of cycles of the core clock. For example, if the number of cycles of the divided signal is T times as much as that of the core clock, the period register 52 retains the value of “T”.

The divider 53 calculates a value by dividing the value retained in the period register 52 by the division ratio that was used when the CD 4 generates the divided signals. For example, when the period register 52 stores therein the value of “T” and when the CD 4 generates the divided signals by multiplying the cycle of the reference signal by “N”, the divider 53 outputs the calculated value of “T/N” and a remainder. Specifically, by dividing the value that indicates the cycle of the divided signals by the division ratio, the divider 53 calculates the cycle of the reference signal that is the original of the divided signals.

The sub-period register 54 retains the value that is output from the divider 53 at the timing when the AND gate 59, which will be described later, outputs a control signal. Specifically, the sub-period register 54 retains the value in which the cycle of the reference signal is indicated by a value of the cycle of the core clock in the CPU 10. In other words, the sub-period register 54 retains the value that indicates the cycle of the control signal. For example, if the number of cycles of the control signal is eight times as much as that of the core clock in the CPU 10, the value “8” is stored in the sub-period register 54.

The sub-phase counter 55 is a counter that indicates the phase of the control signal by using the number of the cycles of the core clock in the CPU 10. Specifically, the sub-phase counter 55 increments its own value in accordance with the pulse signal that is output from the second comparator 58, which will be described later. Then, when the sub-phase counter 55 receives a pulse signal from the rising edge detector 31 or when the value obtained by adding 1 to the counted value matches the value stored in the sub-period register 54, the sub-phase counter 55 resets the counted value to “0”. Specifically, the sub-phase counter 55 resets the value counted at the same cycle as that of the reference signal to “0”.

The first comparator 56 is a comparator that outputs a signal that indicates “1” to the AND gate 59 when the value of the sub-phase counter 55 is “0”. Specifically, the first comparator outputs a pulse signal at the same cycle as that of the reference signal.

The residual pulse counter 57 counts the number of residual pulse signals that are to be generated as control signals. Specifically, every time a predetermined value of “N” is set when a pulse signal is received from the rising edge detector 31 and the control signal is sent from the AND gate 59, the residual pulse counter 57 decrements the set value. Furthermore, when the residual pulse counter 57 does not receive a pulse signal from the rising edge detector 31 nor a control signal, the residual pulse counter 57 retains its own value. Furthermore, the second comparator 58 outputs the signal “1” when the value set in the residual pulse counter 57 is not “0”.

When the first comparator 56 and the second comparator 58 output the signal “1”, the AND gate 59 outputs the signal “1”. Specifically, when the value of the residual pulse counter 57 is other than “0” and the value of the sub-phase counter 55 is “0”, the AND gate 59 outputs a signal, i.e., a control signal, of “1” by an amount of one cycle of the core clock.

When “0” is set in the control register 37, the AND gate 60 outputs a control signal to the STICK registers 12, 13, 15, and 16 via the path illustrated by (O) in FIG. 3.

Specifically, the n-pulse generating unit 50 complements a divided signal received from the CD 4 and then generates a control signal with the same frequency as that of the reference signal before it is divided. When the synchronization control mechanism 17 receives a synchronization request and when the phase of a divided signal indicated by the phase counter 32 reaches the “REG-WR Timing”, the synchronization control mechanism 17 outputs the control signal generated by the n-pulse generating unit 50 to each of the STICK registers 12, 13, 15, and 16. Consequently, even when the synchronization control mechanism 17 starts the synchronization process in accordance with the timing that is indicated by the divided signal obtained by dividing the reference signal, the synchronization control mechanism 17 can also appropriately synchronize each of the CPUs 10 to 10b and 18 to 18b.

Because the n-pulse generating unit 50 can be implemented by a relatively small number of flip flops (FFs), the cost is small and implementation is easy. Furthermore, when compared with the phase locked loop (PLL), i.e., a phase synchronization circuit, which is an analog circuit, the entirety of the n-pulse generating unit 50 is made up of a digital logical circuit. Consequently, the n-pulse generating unit 50 can operate normally without miscalculating the number of pulses to be output even if the variation in frequency is great, which is difficult to keep up with in a PLL. Furthermore, the n-pulse generating unit 50 may also be implemented in a typical PLL.

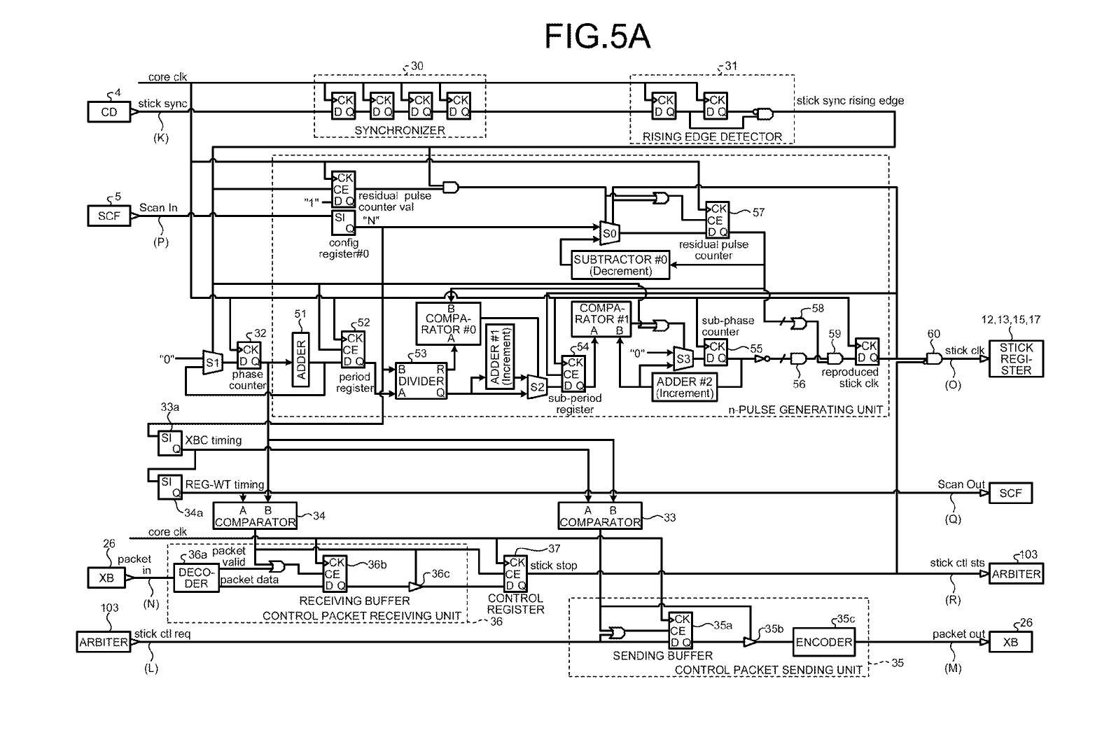

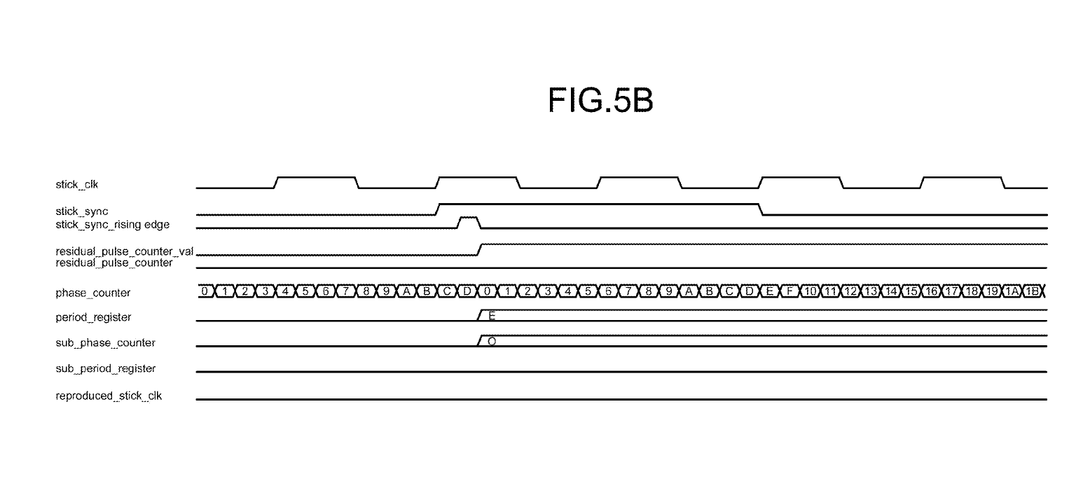

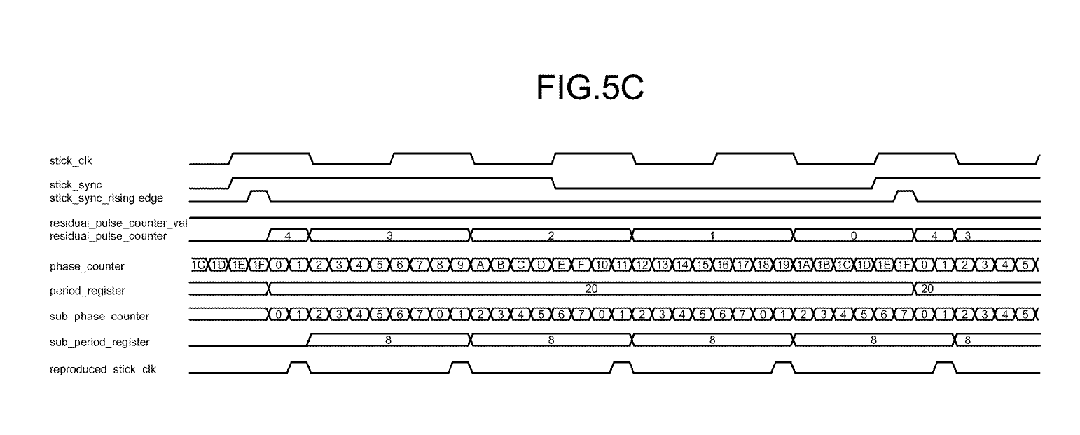

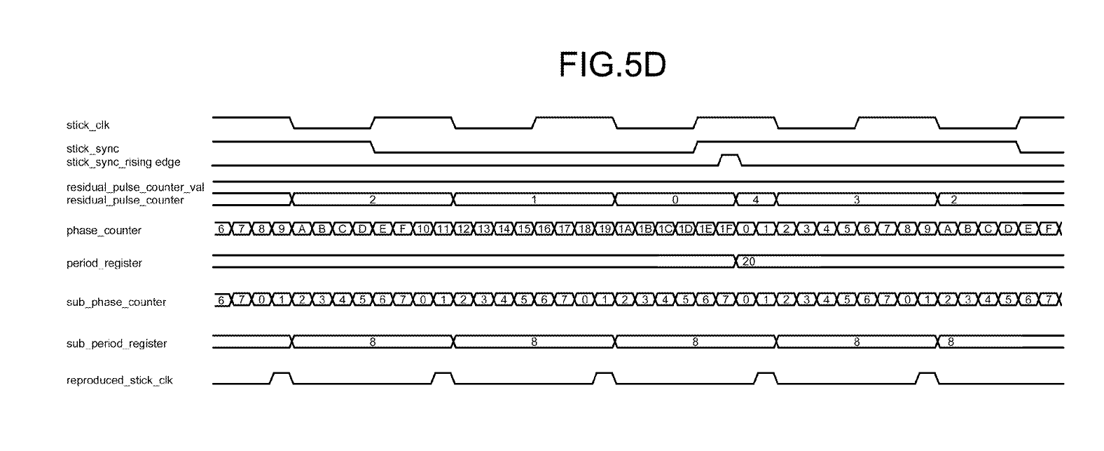

In the following, an example of the synchronization control mechanism 17 will be described with reference to FIG. 5A. FIG. 5A is a schematic diagram illustrating an example of the synchronization control mechanism according to the first embodiment. The synchronization control mechanism 17 illustrated in FIG. 5A is only an example. Each of the units 30 to 37 and 50 to 60 included in the synchronization control mechanism 17 may also be replaced with, for example, a circuit that has the same function as that performed by each of the units 30 to 37 and 50 to 60.

In the example illustrated in FIG. 5A, a core clock in the CPU 10 is represented by “core clk”, a synchronization signal supplied from the CD 4 is represented by “stick sync”, and a synchronization request that is input from an application via the arbiter 103 is represented by “stick ctl req”. Furthermore, a control signal generated by the n-pulse generating unit 50 is represented by “stick clk”. The paths illustrated by (K) to (O) in FIG. 5A correspond to the paths illustrated by (K) to (O), respectively, in FIG. 3.

In the example illustrated in FIG. 5A, by using multiple D-type flip-flop (hereinafter, referred to as a D-FF), the synchronizer 30 matches the phase of the core clk with the phase of the stick sync signal that is acquired via the path illustrated by (K) in FIG. 5A. By connecting two D-FFs in series in which the core clk is used as the clock and by outputting “1” when an output from the D-FF arranged on the upstream side is “1” and an output from the D-FF arranged on the downstream side is “0”, the rising edge detector 31 detects the rising edge of a stick sync. In the description below, an output from the rising edge detector 31 is represented by the “stick sync rising edge”. The stick sync rising edge is input to the multiplexer S1 as a selection control signal. When the stick sync rising edge is “1”, the signal that is output from the adder 51 is looped back to the phase counter 32 and, in the other cases, “0” is input.

The phase counter 32 retains a signal sent from the multiplexer S1. Specifically, the value retained in the phase counter 32 is reset to 0 when the stick sync rising edge is “1”, whereas the value is counted by the adder 51 when the stick sync rising edge is “0”.

The period register 52 latches an output of the adder 51 when the stick sync rising edge is “1”. The divider 53 outputs a value obtained by dividing an output of the period register 52 by the value “N” that is stored in the config register #0 and that is set in advance. The comparator #0 outputs “1” when the value of the residual pulse counter 57 is equal to or less than the value of remainder that is output from the terminal R by the divider. The comparator #0 outputs, to the sub-period register 54, a signal that sets a value obtained by dividing a value of the period register by “N+1”. This signal is used, if the value in the period register 52 is indivisible by N, to correct the value stored in the sub-period register 54.

The adder #1 adds 1 to the quotient that is output from the terminal Q of the divider 53 and input the added value to the multiplexer S2. The multiplexer S2 inputs, to the adder #1, an output from the comparator #0 as a selection control signal or inputs, to the sub-period register 54, the quotient that is output from the divider 53. Specifically, if the value of the period register 52 is indivisible by N by using an output from the comparator #0, the multiplexer S2 corrects the value stored in the sub-period register 54.

The sub-period register 54 retains an output from the multiplexer S2. The comparator #1 compares the value retained in the sub-period register 54 with the value that is obtained by adding, by the adder #2, 1 to the value retained in the sub-phase counter 55. When the value retained in the sub-period register 54 matches the value that is obtained by adding 1 to the value retained in the sub-phase counter 55, the comparator #1 outputs “1” to an OR gate that takes the logical disjunction with the stick sync rising edge.

An output from the OR gate corresponds to a selection control signal of the logical disjunction of the multiplexer S3. When the stick sync rising edge is “1” or when the value retained in the sub-period register 54 matches the value that is obtained by adding 1 to the value of the sub-phase counter 55, the multiplexer S3 outputs “0” to the sub-phase counter 55. In a case other than this, the multiplexer S3 inputs, to the sub-phase counter 55, the value of an output from the adder #2, i.e., the value obtained by adding 1 to the value of the sub-phase counter 55. The sub-phase counter 55 indicates an output from the multiplexer S3, i.e., the phase of a control signal, as the number of cycles of the core clock in the CPU 10.

The adder #2 inputs, to the comparator #1 and the multiplexer S3, the value obtained by adding 1 to the output from the sub-phase counter 55. Furthermore, when the stick sync rising edge is 1 and the value of the residual pulse counter 57 is 1, “N” is set in the residual pulse counter 57 by a comparator S0. Furthermore, when the reproduced stick clk is “1”, the value of the residual pulse counter 57 is decremented by a subtractor #0. When the residual pulse counter 57 is in neither state, the value stored in the residual pulse counter 57 is retained.

At this point, the “residual pulse counter val”, which is generated from the core clk and the stick sync rising edge, is input to the selection control signal in the comparator S0. This residual pulse counter val is a signal that prevents an output of the reproduced stick clk, whose cycle has not been determined, immediately after the n-pulse generating unit 50 starts its operation.

The first comparator 56 outputs “1” to the AND gate 59 when the value of the sub-phase counter 55 is “0”. The second comparator 58 inputs “1” to the AND gate 59 when the value of the residual pulse counter 57 is not “0”. The AND gate 59 inputs, to a D-FF, an output in accordance with the outputs from the first comparator 56 and the second comparator 58. The AND gate 59 outputs the reproduced stick clk. Specifically, the reproduced stick clk is a signal that takes “1” by a single core clock when the value of the residual pulse counter 57 is not “0” and when the value of the sub-phase counter 55 is “0”. As described above, the n-pulse generating unit 50 generates the reproduced stick clk and sends the generated reproduced stick clk to the STICK registers 12, 13, 15, and 16 via the path illustrated by (O) in FIG. 5A.

In the following, a description will be given of a process that sets the “XBC Timing” and the “REG-WR Timing”. For example, the synchronization control mechanism 17 acquires the Scan In signal from the SCF 5 via the paths illustrated by (P) in FIG. 5A. The synchronization control mechanism 17 sets “N” in the config register #0 in the n-pulse generating unit 50 by using the Scan In signal.

Furthermore, in the synchronization control mechanism 17, by using the Scan In signal, the value of the phase counter 32 indicating the “XBC Timing” is set in the setting register 33a and the value of the phase counter 32 indicating the “REG-WT Timing” is set in the setting register 34a. Furthermore, the synchronization control mechanism 17 sends the Scan Out signal to the synchronization control mechanism 25 via the path illustrated by (Q) in FIG. 5A. Similarly, in the synchronization control mechanism 25, by using the Scan In signal, the “XBC Timing” and the “REG-WR Timing” are set and then the Scan Out signal is sent to the SCF 5.

When the value stored in the setting register 33a matches the value of the phase counter 32, the comparator 33 outputs “1”. Furthermore, when the value stored in the setting register 34a matches the value of the phase counter 32, the comparator 34 outputs “1”.

In the following, examples of the control packet sending unit 35 and the control packet receiving unit 36 will be described. In the example illustrated in FIG. 5A, it is assumed that, when the stick ctl req is “1”, a control packet is broadcast. For example, the control packet sending unit 35 acquires the stick ctl req from the arbiter 103 via the path illustrated by (L) in FIG. 5A and then stores the value of the stick ctl req in the sending buffer 35a.

When the comparator 33 determines that the value stored in the setting register 33a matches the value of the phase counter 32, the value stored in the sending buffer 35a is sent to the encoder 35c by the output circuit 35b that is a 3-state buffer. Specifically, the value stored in the sending buffer 35a is stored in a control packet when the comparator 33 outputs “1”, i.e., at the “XBC Timing”, and is broadcast to each of the CPUs 10 to 10b and 18 to 18b via the path illustrated by (M) in FIG. 5A.

Furthermore, the decoder 36a in the control packet receiving unit 36 receives a control packet via the path illustrated by (N) in FIG. 5A and acquires information that is stored in “W” in the received packet and that indicates the operation content of the STICK registers. Specifically, the decoder 36a acquires “0” that indicates the starting of the synchronization of the STICK registers or acquires “1” that indicates the stopping of the synchronization of the STICK registers. Then, the decoder 36a outputs “packet valid” indicating that a packet has been received and then outputs “0” or “1” that is packet data.

The receiving buffer 36b retains “0” or “1” that is the packet data output from the decoder. The update circuit 36c, which is a 3-state buffer, retains, in the control register 37, the value that is retained in the receiving buffer 36b when the comparator 33 outputs “1”, i.e., at the “REG-WR Timing”. At this point, the value that will be stored in the control register 37 is inverted and then is input to the AND gate 60. Consequently, when “0” is stored in the control register 37, the stick clk is supplied to the STICK registers 12, 13, 15, and 16 and, when “1” is stored in the control register 37, the supply of the stick clk is stopped.

Each of the setting registers 33a and 34a and the config register #0 illustrated in FIG. 5A is set by a mechanism, such as the joint test action group (JTAG) or an inter integrated circuit (I2C) that are independent of STICK. In the example illustrated in FIG. 5A, the registers are set by using a scan signal for the JTAG.

In the following, descriptions will be given, with reference to FIGS. 5B to 5D, of examples of signal waveforms that are output from circuits and a value stored in each counter illustrated in FIG. 5A. FIG. 5B is a schematic diagram illustrating an example of the operation of the synchronization control mechanism (1). FIG. 5C is a schematic diagram illustrating an example of the operation of the synchronization control mechanism (2). FIG. 5D is a schematic diagram illustrating an example of the operation of the synchronization control mechanism (3). FIGS. 5B to 5D illustrates examples of waveforms obtained by dividing the signal waveform that indicates an example of the operation of the synchronization control mechanism into three. Furthermore, in the examples illustrated in FIGS. 5B to 5D, it is assumed that the number of cycles of the stick_sync is four times as much as that of the stick_clk that is the reference signal that is divided by one of the CDs 4 to 4b. It is also assumed that N is 4. Furthermore, the values illustrated in FIGS. 5B to 5d are values that are counted by each of the counters, that are stored in each of the registers, and that are represented by hexadecimal numbers.

As illustrated in FIG. 5B, when the stick_sync with cycles the number of which is four times as much as that of the stick_clk is output, the stick_sync_rising edge is output and the value of the phase_counter is reset. Furthermore, the stick_sync_rising edge is used as a trigger; the value obtained by adding “1” to the value that is obtained immediately before the phase_counter is stored in the period register 52; and “0” is stored in the sub_phase_counter.

Then, as illustrated in FIG. 5C, when the subsequent stic_sync_rising edge is detected, “20” represented in hexadecimal numbers (“32” represented in decimal numbers) is stored in the period_register and “4” represented in a hexadecimal number is stored in the residual_pulse_counter. Furthermore, because “8” represented in a hexadecimal number is stored in the sub_period_counter, the sub_phase_counter counts the values of 0 to 7. Consequently, the reproduced_stick_clk at a cycle corresponding to a factor of eight times of the core clock.

Furthermore, as illustrated in FIG. 5D, the n-pulse generating unit 50 continuously outputs the reproduced_stick_clk with cycles the number of which is eight times as much as that of the core clock. Then, the synchronization control mechanism 17 supplies the pulse signal generated by the n-pulse generating unit 50 to each of the STICK registers 12, 13, 15, and 16 at the “REG-WR Timing”.

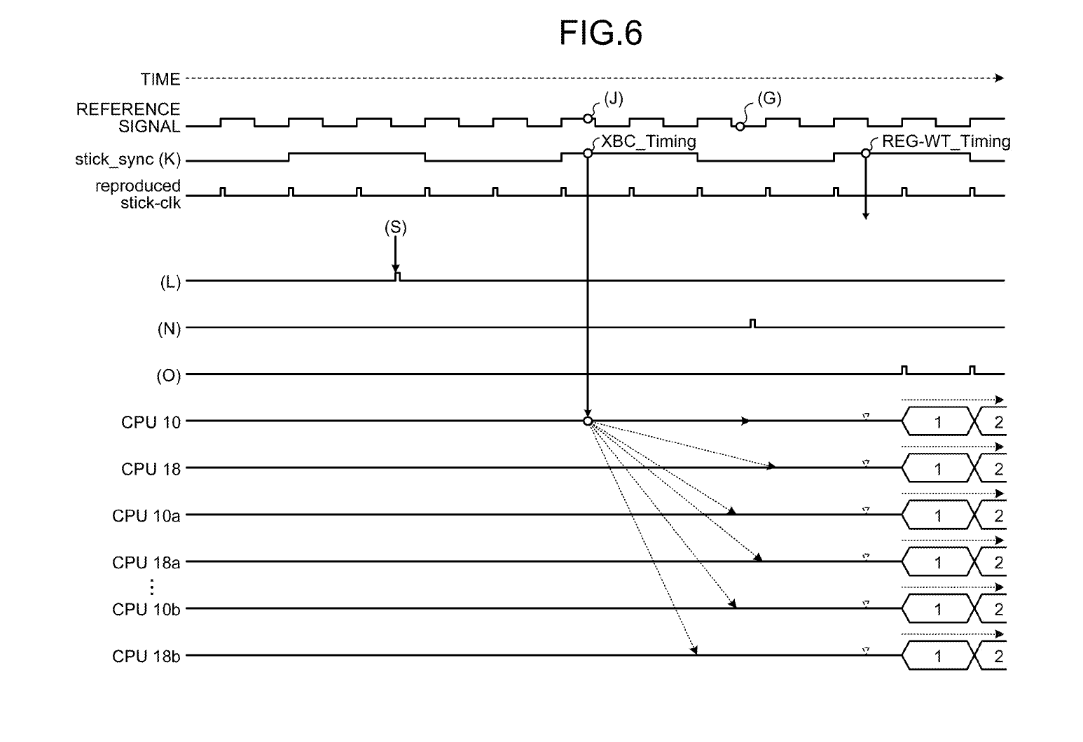

In the following, a description will be given, with reference to FIG. 6, of the timing at which each of the CPUs 10 to 10b and 18 to 18b starts synchronization. FIG. 6 is a timing chart illustrating the timing at which counting at a STICK register according to the first embodiment is started. In the example illustrated in FIG. 6, it is assumed that the time passes from the left to the right side. Furthermore, FIG. 6 illustrates waveforms of the reference signal, waveforms of the stick_sync of the divided signal that is acquired via the path illustrated by (K) in FIG. 5A, and waveforms of the reproduced stick_clk that is generated by the n-pulse generating unit. Furthermore, FIG. 6 illustrates waveforms of the signals passing through the paths illustrated by (L), (M), and (O) in FIG. 5A and also illustrates values stored in each of the STICK registers in the corresponding CPUs 10 to 10b and 18 to 18b. Furthermore, in the example illustrated in FIG. 6, it is assumed that each of the CPUs 10 to 18b receives a packet at the timing indicated by the dotted lines with the arrows. The waveforms of the signal received by each of the CPUs 10 to 18b is simply illustrated.

For example, when an application sends a synchronization request via the path illustrated by (L) in FIG. 5A at the timing illustrated by (S) in FIG. 6, a control packet is broadcast to each of the CPUs 10 to 10b and 18 to 18b at the “XBC_Timing” that appears subsequent to the timing (S). At this point, the “XBC_Timing” is the elapsed time of the number of cycles of the core clock stored in the setting register 33a since the rising edge of the styck_sync.

In this example, each of the CPUs 10 to 10b and 18 to 18b, each of the XBs 26 to 26b, and the bus 7 are connected by a serial link in which the transmission latency varies. Consequently, as illustrated in FIG. 6, each of the CPUs 10a, 10b, and 18 to 18b acquires a control packet at a different timing. Furthermore, the CPU 10 also acquires, from the path illustrated by (N) in FIG. 5A, a control packet that was broadcast by the CPU 10 itself.

Then, each of the CPUs 10 to 10b and 18 to 18b starts to output the reproduced_stick_clk at the “REG-WR_Timing”. At this point, the “REG-WR_Timing” is the elapsed time of the number of cycles of the core clock stored in the setting register 34a since the rising edge of the stick_sync.

As described above, each of the CPUs 10 to 10b and 18 to 18b sends a control packet and outputs the reproduced_stick_clk in accordance with the “XBC_Timing” and the “REG-WT_Timing” indicated by the divided signal that is obtained by dividing the reference signal. At this point, the stick_sync has a long cycle that is N times as long as that of the reference signal. Consequently, the intervals of the “XBC_Timing” and the “REG-WT_Timing” indicated by the stick_sync are longer than those indicated by the reference signal.

Consequently, because each of the CPUs 10 to 10b and 18 to 18b can absorb variations of the transmission latency, even when the CPUs receive control packets at different timings, the CPUs can simultaneously start to supply the reproduced_stick_clk. Consequently, each of the CPUs 10 to 10b and 18 to 18b can make the values to be stored in the STICK registers the same and thus synchronously execute the processes.

As described above, the synchronization control mechanism 17 receives divided signals that are obtained by dividing the reference signal into low frequency signals. Furthermore, when the CPU 10 synchronizes with each of the CPUs 10 to 10b and 18 to 18b, the synchronization control mechanism 17 broadcasts a control packet in which a synchronization request is stored to the CPUs 10 to 10b and 18 to 18b as the destinations. When the synchronization control mechanism 17 receives a control packet that is sent by itself or that is sent by one of the other synchronization control mechanisms 17a, 17b, and 25 to 25b, the synchronization control mechanism 17 starts synchronization control in accordance with the timing that is indicated by the received divided signal. Consequently, even when the CPUs 10 to 10b and 18 to 18b are connected by way of a method in which the transmission latency varies, the synchronization control mechanism 17 can start synchronization at an appropriate timing.

Specifically, each of the CPUs 10 to 10b and 18 to 18b specifies the “REG-WR Timing” in accordance with the divided signal that has a longer cycle than that of the reference signal and then starts the synchronization control at the specified timing. Consequently, each of the CPUs 10 to 10b and 18 to 18b can obtain the resistance to variations in the transmission latency of a synchronization request.

Furthermore, even when the CPUs 10 to 10b and 18 to 18b are connected by way of a connection method in which, like a serial link technique, simultaneous delivery of synchronization requests is not guaranteed, the CPUs 10 to 18 can also be appropriately synchronized. Furthermore, by using a mechanism that issues a synchronization request to each of the CPUs 10 to 10b and 18 to 18b, each of the CPUs 10 to 10b and 18 to 18b may also simultaneously send an arbitrary control instruction to each of the CPUs 10 to 10b and 18 to 18b.

Furthermore, the synchronization control mechanism 17 includes the n-pulse generating unit 50 that generates, on the basis of a divided signal, a control signal having the same frequency as that of the reference signal before the reference signal is divided. When the synchronization control mechanism 17 receives a synchronization request, the synchronization control mechanism 17 supplies a control signal to each of the STICK registers 12, 13, 15, and 16 in accordance with the timing indicated by the divided signal. Consequently, the synchronization control mechanism 17 can appropriately synchronize the processes. Specifically, because the synchronization control mechanism 17 appropriately synchronizes the values stored in the STICK registers 12, 13, 15, and 16, the synchronization control mechanism 17 appropriately synchronizes the CPUs 10 and 18.

As described above, a divided signal is input to each of the CPUs 10 to 10b and 18 to 18b with the minim skew. Each of the synchronization control mechanisms 17 to 17b and 26 to 26b generates a control signal having the same frequency as that of the reference signal and then outputs the control signal to each of the STICK registers. Consequently, the parallel computer system 1 can appropriately synchronize the processes executed by each of the CPUs 10 to 10b and 18 to 18b.

### [b] Second Embodiment

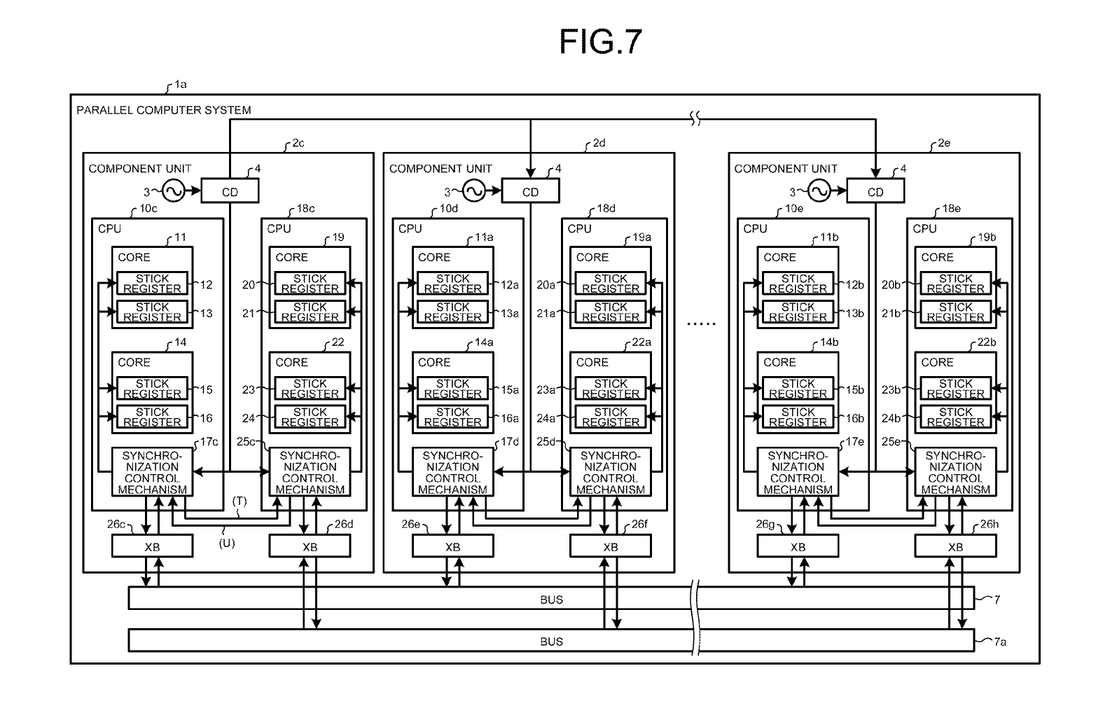

In a second embodiment, an example of the parallel computer system will be described with reference to FIG. 7. FIG. 7 is a schematic diagram illustrating an example of a parallel computer system according to a second embodiment. In the example illustrated in FIG. 7, components having the same functions as those performed by the components in the parallel computer system 1 according to the first embodiment are assigned the same reference numerals; therefore, descriptions thereof will be omitted. As illustrated in FIG. 7, a parallel computer system 1a includes multiple component units 2c to 2e and multiple buses 7 and 7a. It is assumed that the component units 2d and 2e have the same function as that performed by the component unit 2c; therefore, descriptions of the component units 2d and 2e will be omitted.

The component unit 2c includes the oscillator 3, the CD 4, a CPU 10c, a CPU 18c, an XB 26c, and an XB 26d. It is assumed that the CPU 10c is connected to the bus 7 via the XB 26c and assumed that the CPU 18c is connected to the bus 27 via the XB 26d. Furthermore, it is assumed that the CPU 10c, the XB 26c, and the bus 7 are connected by a serial link. Furthermore, it is assumed that the CPU 18c, the XB 26d, and the bus 7a are connected by a serial link.

The bus 7 is a bus that connects the CPUs 10c, 10d, and 10e via the XBs 26c, 26e, and 26g. Furthermore, the bus 7a is a bus that connects the CPUs 18c, 18d, and 18e via the XBs 26d, 26f, and 26h. Furthermore, the CPUs 10c and 18c included in the component unit 2c are connected with each other.

Specifically, in the parallel computer system 1a, two CPUs included in each of the component units 2c to 2e are assumed to be a separate group. Each of the groups is connected via a different bus. Between the CPUs in each group, the CPUs 10c to 10e are connected by the bus 7 and the CPUs 18c to 18e are connected via the bus 7a.

The CPUs 10c to 10e and 18c to 18e include synchronization control mechanisms 17c to 17e and 25c to 25e, respectively. In the description below, it is assumed that the synchronization control mechanisms 17d, 17e, and 25c to 25e perform the same process as that performed by the synchronization control mechanism 17c; therefore, descriptions thereof will be omitted. Furthermore, it is assumed that the XBs 26c to 26h perform the same function as that performed by the XB 26 according to the first embodiment; therefore, descriptions thereof will be omitted.

When the synchronization control mechanism 17c synchronizes the processes executed by the CPUs 10c to 10e and 18c to 18e, the synchronization control mechanism 17c sends a control packet in which a synchronization request is stored to the synchronization control mechanism 25c via the path illustrated by (T) in FIG. 7. Thereafter, when the synchronization control mechanism 17c receives the control packet from the synchronization control mechanism 25c via the path illustrated by (U) in FIG. 7 or when a predetermined time period has elapsed after the synchronization control mechanism 17c sends the control packet, the synchronization control mechanism 17c executes the following process. Namely, the synchronization control mechanism 17c broadcasts the control packet in which the synchronization request is stored to each of the CPUs 10c to 10e that are connected to the bus 7.

At this point, when the synchronization control mechanism 25c receives the control packet in which the synchronization request is stored from the synchronization control mechanism 17c, the synchronization control mechanism 25c executes the following process. Namely, the synchronization control mechanism 25c broadcast the control packet to the CPUs 18c to 18e at the same time when the synchronization control mechanism 17c broadcasts the control packet to each of the CPUs 10c to 10e.

Then, each of the synchronization control mechanisms 17c to 17e and 25c to 25e receives the broadcast control packet. Then, each of the synchronization control mechanisms 17c to 17e and 25c to 25e supplies the control signal to the STICK registers in the CPUs 10c to 10e and 18c to 18e, respectively, at the “REG-WR Timing” at which a predetermined time has elapsed since the rising edge of the divided signal.

Specifically, the synchronization control mechanism 17c synchronizes with another synchronization control mechanism 25c that is in the component unit 2c that includes the synchronization control mechanism 17c itself. Then, the synchronization control mechanism 17c broadcasts a control packet to each of the CPUs 10c to 10e connected to the bus 7. Furthermore, when the synchronization control mechanism 17c receives a control packet from the synchronization control mechanism 25c, the synchronization control mechanism 17c also broadcasts the control packet to each of the CPUs 10c to 10e connected to the bus 7.

As described above, when the CPUs 10c to 10e and 18c to 18e are connected to a different bus, the synchronization control mechanisms 17c to 17e and 25c to 25e each send a synchronization request to a synchronization control mechanism in a CPU that is connected to a bus that is different from the bus connected to the CPU that includes the corresponding synchronization control mechanism. Then, each of the synchronization control mechanisms 17c to 17e and 25c to 25e sends the synchronization request to the CPUs that are connected to the same bus as that connected to the CPU that includes the corresponding synchronization control mechanism. In this way, each of the synchronization control mechanisms 17c to 17e and 25c to 25e gradually sends the synchronization request to the CPUs 10c to 10e and 18c to 18e.

Then, each of the synchronization control mechanisms 17c to 17e and 25c to 25e outputs the synchronization signal to the STICK register included in each of the CPUs 10c to 10e and 18c to 18e at the “REG-WR Timing” at which a predetermined time has elapsed since the rising edge of the divided signal. Consequently, the parallel computer system 1a can synchronize the processes executed by the CPUs 10c to 10e and 18c to 18e.

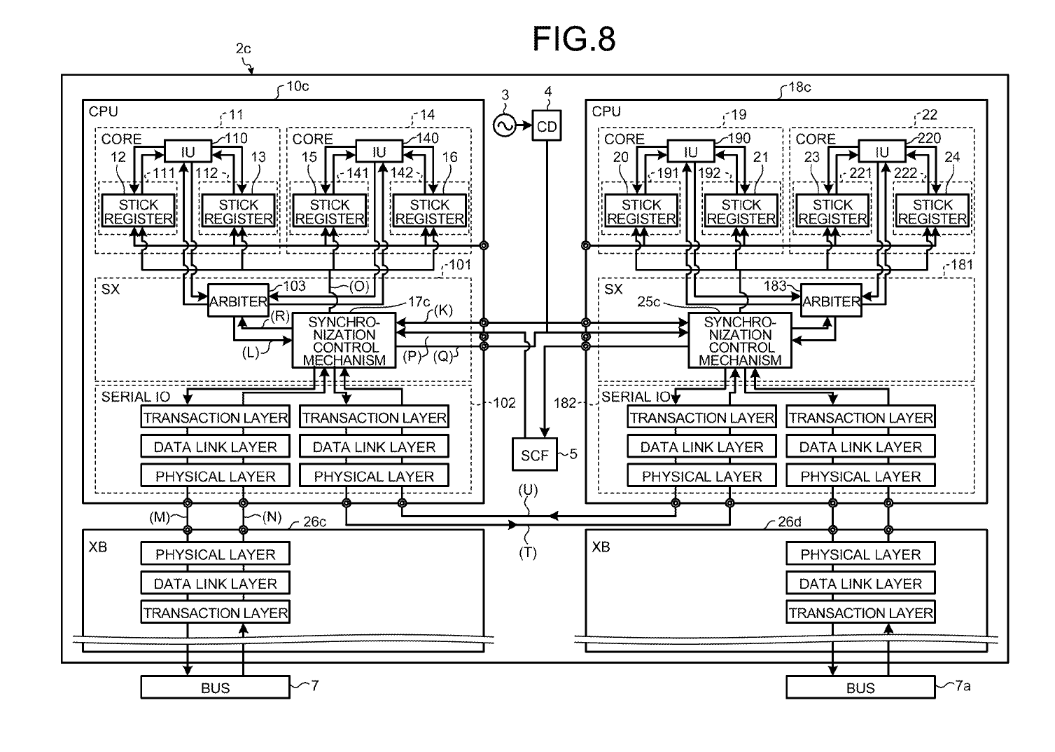

FIG. 8 is a schematic diagram illustrating an example of a CPU according to the second embodiment. It is assumed that the components illustrated in FIG. 8 having the same reference numerals as those illustrated in FIG. 2 execute the same process as that executed by the components according to the first embodiment; therefore, descriptions thereof will be omitted. Furthermore, it is assumed that the paths illustrated by (K) to (R) in FIG. 8 correspond to the paths illustrated by (K) to (R) in FIG. 2, respectively; therefore, descriptions thereof in detail will be omitted.

When an application issues a synchronization request via the arbiter 103, the synchronization control mechanism 17c sends a control packet in which the synchronization request is stored to the synchronization control mechanism 25c via the path illustrated by (T) in FIG. 8. Furthermore, when the synchronization control mechanism 25c acquires a synchronization request that was issued by the application and when the synchronization control mechanism 25c sends a control packet, the synchronization control mechanism 17c receives the control packet via the path illustrated by (U) in FIG. 8.

When a predetermined time period has elapsed since the synchronization control mechanism 17c sent the control packet or when the synchronization control mechanism 17c receives the control packet sent from the synchronization control mechanism 25c, the synchronization control mechanism 17c broadcasts the control packet to each of the CPUs 10c to 10e connected to the bus 7. Then, similarly to the synchronization control mechanism 17 according to the first embodiment, the synchronization control mechanism 17c supplies the control signal to each of the STICK registers 12, 13, 15, and 16 at the “REG-WR Timing”.

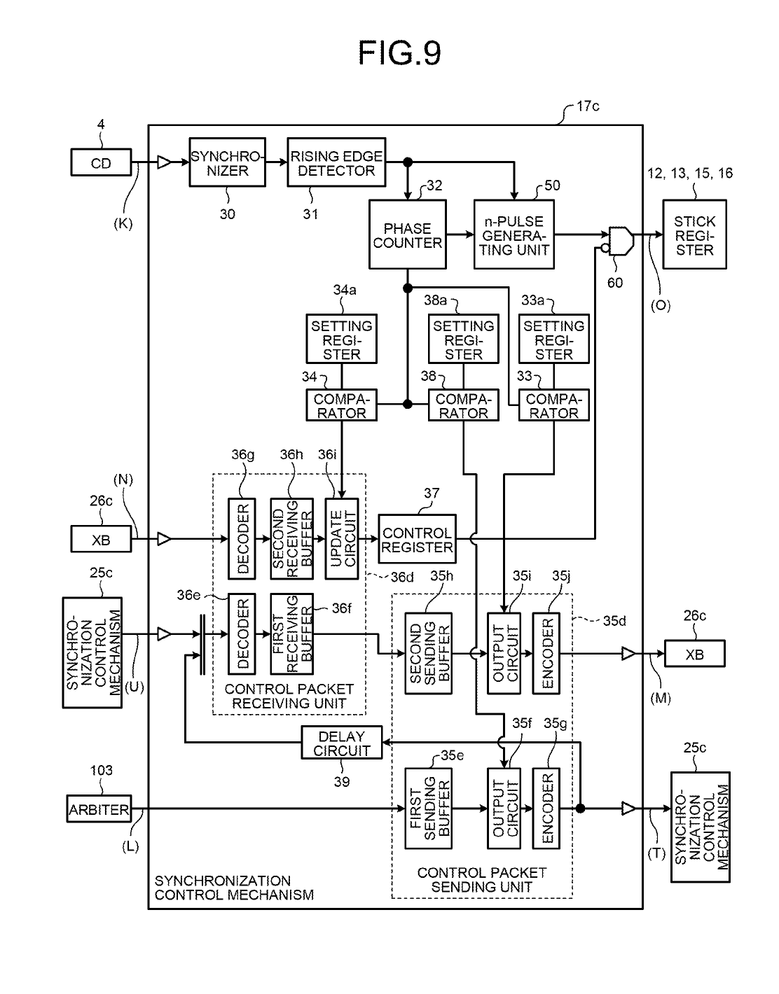

In the following, the synchronization control mechanism 17c will be described with reference to FIG. 9. FIG. 9 is a schematic diagram illustrating a synchronization control mechanism according to the second embodiment. It is assumed that the paths illustrated by (K) to (O) in FIG. 9 correspond to the paths illustrated by (K) to (O) in FIG. 3, respectively. Furthermore, the paths illustrated by (T) and (U) in FIG. 9 correspond to the path illustrated by (T) and (U) in FIG. 8, respectively. Furthermore, components illustrated in FIG. 9 that execute the same processes as those executed by the components illustrated in FIG. 3 are assigned the same reference numerals; therefore, descriptions thereof will be omitted.

As illustrated in FIG. 9, the synchronization control mechanism 17c includes the synchronizer 30, the rising edge detector 31, the phase counter 32, the comparator 33, the setting register 33a, the comparator 34, the setting register 34a, a control packet sending unit 35d, and a control packet receiving unit 36d. The synchronization control mechanism 17c includes the control register 37, a comparator 38, a setting register 38a, a delay circuit 39, the n-pulse generating unit 50, and the AND gate 60.

The control packet sending unit 35d includes a first sending buffer 35e, an output circuit 35f, an encoder 35g, a second sending buffer 35h, an output circuit 35i, and an encoder 35j. The control packet receiving unit 36d includes a decoder 36e, a first receiving buffer 36f, a decoder 36g, a second receiving buffer 36h, and an update circuit 36i.

It is assumed that the first sending buffer 35e and the second sending buffer 35h perform the same function as that performed by the sending buffer 35a illustrated in FIG. 3; assumed that the output circuit 35f and the output circuit 35i perform the same function as that performed by the output circuit 35b; and assumed that the encoder 35g and the encoder 35j performs the same function as that performed by the encoder 35c. Furthermore, it is assumed that the decoder 36e and the decoder 36g perform the same function as that performed by the decoder 36a; assumed that the first receiving buffer 36f and the second receiving buffer 36h perform the same function as that performed by the receiving buffer 36b; and assumed that the update circuit 36i performs the same function as that performed by the update circuit 36c.

Furthermore, it is assumed that an output from the comparator 33 is input to the output circuit 35i, assumed that an output from the comparator 34 is input to the update circuit 36i, and assumed that an output from the comparator 38 is input to the output circuit 35f. Furthermore, similarly to the first embodiment, the setting register 33a stores therein a value that indicates the number of “XBC Timings” appearing since the rising edge of a divided signal and that is indicated by the number of cycles of the core clock. Furthermore, the setting register 34a stores therein a value that indicates the “REG-WR Timing” that appears since the rising edge of a divided signal and that is indicated by the number of cycles of the core clock.

Furthermore, when an application executed by the CPU 10c issues a synchronization request, the synchronization control mechanism 17c receives the synchronization request from the path illustrated by (L) in FIG. 9 and sends a control packet in which the synchronization request is stored to the synchronization control mechanism 25c. In the description below, the timing, at which the synchronization control mechanism 17c sends a control packet to the synchronization control mechanism 25c that is connected to another bus that is different from the bus to which the synchronization control mechanism 17c is connected, is referred to as an “SBC Timing”.

Specifically, the setting register 38a stores therein a value indicating the “SBC Timing” by using, in cycle units, the number of cycles of the core clock that are present since the rising edge of a divided signal. If the value of the phase counter 32 matches the value of the setting register 38a, the comparator 38 outputs a signal to the output circuit 35f. When the output circuit 35f receives a signal from the comparator 38, i.e., when the time reaches the “SBC Timing”, the output circuit 35f outputs the synchronization signal stored in the first sending buffer 35e to the encoder 35g.

The encoder 35g generates a control packet that stores therein the received synchronization signal and then sends the generated control packet to the to the synchronization control mechanism 25c via the path illustrated by (T) in FIG. 9. Furthermore, the encoder 35g also sends the generated packet to the delay circuit 39. The packet generated by the encoder 35g is the same packet as that generated by the encoder 35c according to the first embodiment. When the delay circuit 39 receives the control packet generated by the encoder 35g, the delay circuit 39 outputs the received control packet after a predetermined time has elapsed.

Furthermore, the synchronization control mechanism 17c sends, to the control packet receiving unit 36d, the control packet that was sent by the synchronization control mechanism 25c via the path illustrated by (U) in FIG. 9 or the control packet that was output by the delay circuit 39. Similarly to the control packet receiving unit 36 according to the first embodiment, the control packet receiving unit 36d decodes the control packet by using the decoder 36e and then stores the synchronization request in the first receiving buffer 36f. Furthermore, the control packet receiving unit 36 sends the synchronization request stored in the first receiving buffer 36f to the second sending buffer 35h in the control packet sending unit 35d.

When the second sending buffer 35h receives the synchronization request and when the output circuit 35i receives a signal from the comparator 33, i.e., when the time reaches the timing of the “XBC Timing”, the control packet sending unit 35d executes the following process. Namely, the control packet sending unit 35d generates, by using the encoder 35j, a control packet in which the synchronization request that is stored in the second sending buffer 35h is stored. Then, the control packet sending unit 35d broadcasts the generated control packet to each of the CPUs 10c to 10e via the path illustrated by (M) in FIG. 9.

Furthermore, when the synchronization control mechanism 17c receives, from the XB 26c, the control packet that was broadcast by the synchronization control mechanism 17c itself or the control packet that was broadcast by one of the other synchronization control mechanisms 26e and 26g, the synchronization control mechanism 17c receives the control packet via the path illustrated by (N) in FIG. 9. Furthermore, the synchronization control mechanism 17c decodes the received control packet by using the decoder 36g in the control packet receiving unit 36d and then stores the stored synchronization request in the second receiving buffer 36h. At this point, similarly to the update circuit 36c in the first embodiment, when the update circuit 36i receives a signal from the comparator 34, i.e., when the time reaches the “REG-WR Timing”, the update circuit 36i stores, in the control register 37, the synchronization request that is stored in the second receiving buffer 36h.

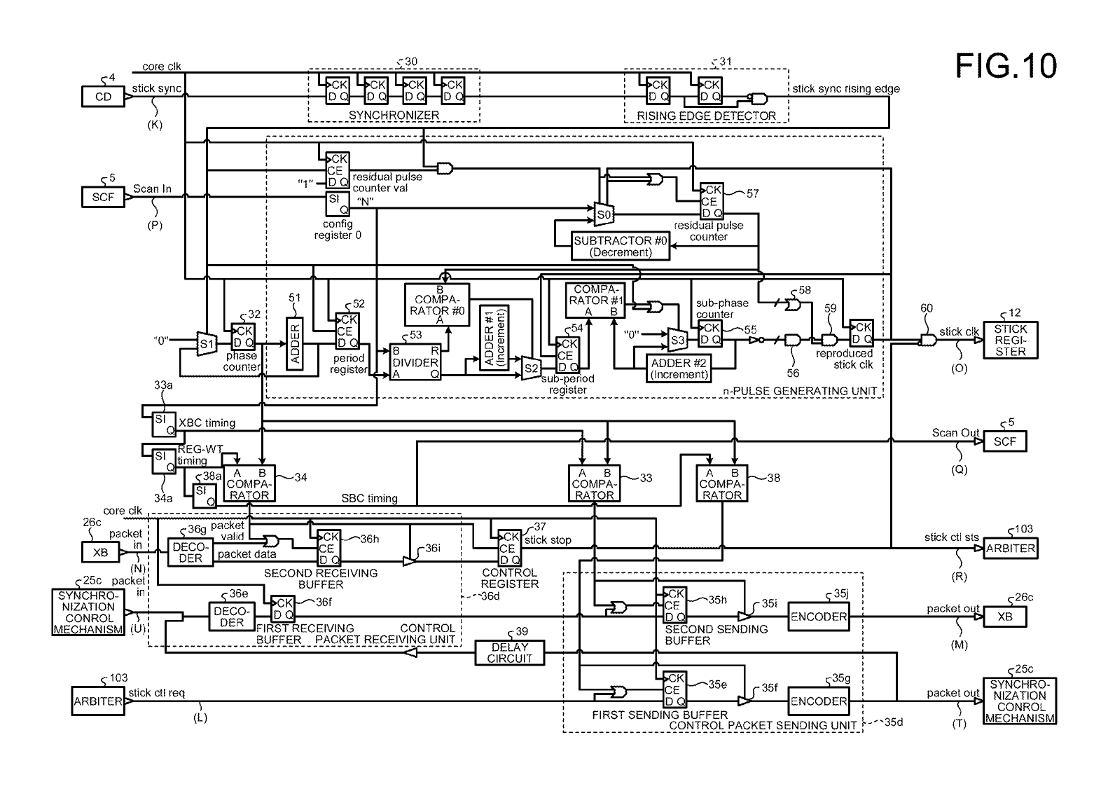

In the following, an example of the synchronization control apparatus 17c according to the second embodiment will be described with reference to FIG. 10. FIG. 10 is a schematic diagram illustrating an example of the synchronization control mechanism according to the second embodiment. The synchronization control mechanism 17c illustrated in FIG. 10 is only an example, each of the units 30 to 38a and 50 to 60 in the synchronization control mechanism 17c may also be replaced with, for example, a circuit that has the same function as that performed by each of the units 30 to 38a and 50 to 60.

In the synchronization control mechanism 17c illustrated in FIG. 10 differs from the synchronization control mechanism 17 illustrated in FIG. 5A in that the comparator 38, the setting register 38a, and the delay circuit 39 are added; the control packet sending unit 35d is used instead of the control packet sending unit 35; and the control packet receiving unit 36d is used instead of the control packet receiving unit 36.

As illustrated in FIG. 10, the first sending buffer 35e receives, from the arbiter 103 via the path illustrated by (L) in FIG. 10, the stick ctl req that is issued by the application and then retains the received stick ctl req. The output circuit 35f is a 3-state buffer. When the comparator 38 outputs “1”, the output circuit 35f sends the stick ctl req that is stored in the first sending buffer 35e to the encoder 35g. The encoder 35g generates a control packet in which the stick ctl req is stored and then sends the generated control packet to the synchronization control mechanism 25c via the path illustrated by (T) in FIG. 10.

When the decoder 36e in the control packet receiving unit 36d receives the control packet from the synchronization control mechanism 25c via the path illustrated by (U) in FIG. 10 or when the decoder 36e receives a control packet that was delayed by the delay circuit 39, the decoder 36e executes the following process. Namely, the decoder 36e decodes the received packet and extracts the synchronization request. Then, the decoder 36e stores the extracted synchronization request in the first receiving buffer 36f.

The synchronization request that is stored in the first receiving buffer 36f is delivered to the second sending buffer 35h in the control packet sending unit 35d and then is stored. Thereafter, similarly to the output circuit 35b, when the output circuit 35i receives a signal from the comparator 33 at the “XBC Timing”, the output circuit 35i outputs the synchronization request that is stored in the second sending buffer 35h to the encoder 35j. Similarly to the encoder 35c, the encoder 35j generates a control packet in which the synchronization request is stored and broadcasts the generated control packet to each of the CPUs 10c to 10e via the path illustrated by (M) in FIG. 10.

If the control packet receiving unit 36d receives the broadcast control packet via the path illustrated by (N) in FIG. 10, the control packet receiving unit 36d executes the same process as that executed by the control packet receiving unit 36d according to the first embodiment. Specifically, the control packet receiving unit 36d extracts, from the control packet by using the decoder 36g, a synchronization request that indicates either “0” or “1” and then stores the extracted synchronization request in the second receiving buffer 36h. When the time reaches the “REG-WR Timing”, the control packet receiving unit 36d allows the control register 37 to retain the value stored in the second receiving buffer 36h, whereby the supply of the stick clk is started or stopped.

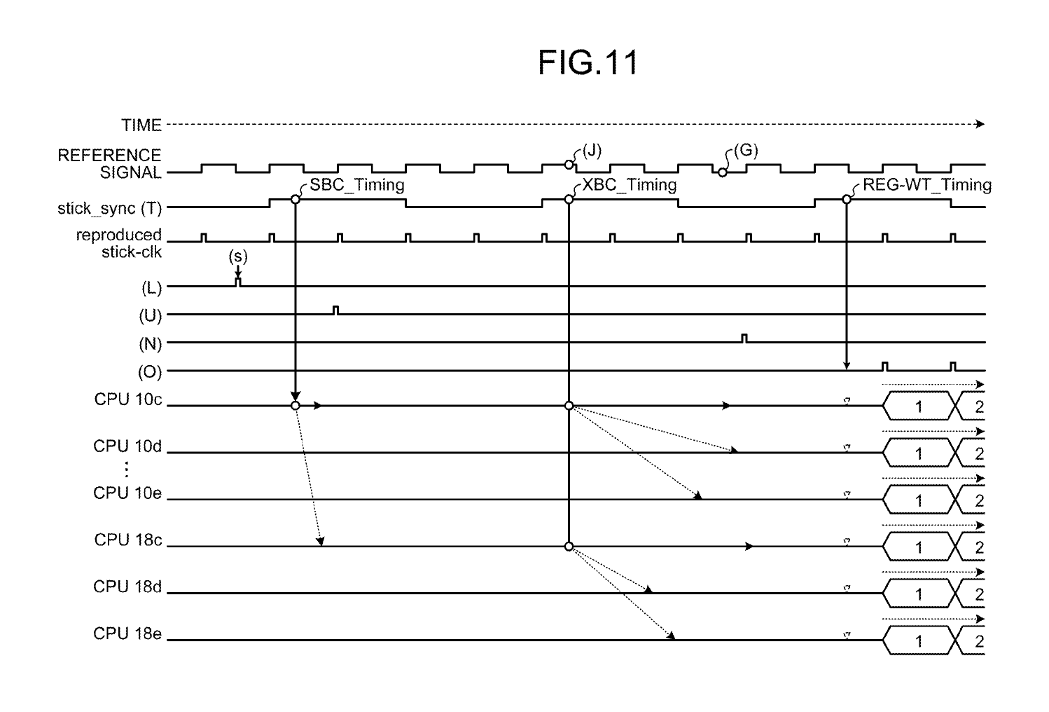

In the following, a synchronization process executed by each of the CPUs 10c to 10e and 18c to 18e will be described with reference to FIG. 11. FIG. 11 is a timing chart illustrating the timing at which counting at a STICK register according to the second embodiment is started. In the example illustrated in FIG. 11, it is assumed that the time passes from the left to the right side. Furthermore, FIG. 11 illustrates waveforms of the reference signal, waveforms of the stick_sync of the divided signal that is acquired from the path illustrated by (K) in FIG. 10, and waveforms of the reproduced stick_clk that is generated by the n-pulse generating unit. Furthermore, FIG. 11 illustrates waveforms of the signals passing through the paths illustrated by (L), (U), (N), and (O) in FIG. 10 and also illustrates values stored in each of the CPUs 10c to 10e and 18c to 18e. In the example illustrated in FIG. 11, it is assumed that each of the CPUs 10c to 18e receives a packet at the timing indicated by the dotted lines with the arrows. The waveforms of the signal received by each of the CPUs 10c to 18e are simply illustrated.

For example, when an application sends a synchronization request via the path illustrated by (L) in FIG. 10 at the timing illustrated by (S) in FIG. 11, the synchronization control mechanism 17c sends a control packet to the synchronization control mechanism 25c at the “SBC Timing” that appears subsequent to the timing (S). The “SBC Timing” mentioned here is the time period corresponding to the number of core clocks stored in the setting register 38a has elapsed since the rising edge of the stick sync.

Furthermore, when the synchronization control mechanism 17c receives the control packet that was output from the delay circuit 39 or receives the control packet from the synchronization control mechanism 25c via the path illustrated by (U) in FIG. 10, the synchronization control mechanism 17c broadcasts the control packet to each of the CPUs 10c to 10e at the “XBC Timing”. At this point, the synchronization control mechanism 25c broadcasts the control packet to each of the CPUs 18c to 18e at the same “XBC Timing” as that executed by the synchronization control mechanism 17c.

Then, each of the synchronization control mechanisms 17c to 17e and 25c to 25e receives the broadcast control packet and then outputs the stick-clk to the corresponding STICK register at the subsequent “REG-WT Timing”. Consequently, because the values stored in the STICK registers are the same, each of the CPUs 10c to 10e and 18c to 18e synchronously execute processes.

As described above, when an application issues a synchronization request, the synchronization control mechanism 17c sends a synchronization request to the synchronization control mechanism 25c in the CPU 18c that is associated with the synchronization control mechanism 17c in the component unit 2c. When a predetermined time period has elapsed since the synchronization control mechanism 17c sent a synchronization request or when the synchronization control mechanism 17c receives a synchronization request from the synchronization control mechanism 25c, the synchronization control mechanism 17c broadcasts a control packet to each of the CPUs 10c to 10e at the “XBC Timing” that is indicated by a divided signal.

At this point, the synchronization control mechanism 25c broadcasts the control packet to the CPUs 18c to 18e at the same timing at which the synchronization control mechanism 17c broadcasts the control packet. Then, after the synchronization control mechanism 17c receives the broadcast control packet, when the time reaches the “REG-WR Timing”, i.e., when a predetermined time period has elapsed since the rising edge of a divided signal, the synchronization control mechanism 17c executes the following process. Namely, the synchronization control mechanism 17c supplies a control signal to the STICK registers 12, 13, 15, and 16 in the CPU 10c. Consequently, even when the CPUs 10c to 10e are connected to the CPUs 18c to 18e, respectively, by a different bus, the synchronization control mechanism 17c can appropriately synchronize the processes executed by the CPUs 10c to 10e and 18c to 18e.

Furthermore, the synchronization control mechanisms 17c to 17e and 25c to 25e output a synchronization signal to the STICK registers in each of the CPUs 10 to 10b and 18 to 18b at the “REG-WR Timing” at which a predetermined time has elapsed since the rising edge of the divided signal that is longer than the reference signal. Consequently, even when the CPUs 10c to 10e and 18c to 18e are connected by way of a connection method in which, like as serial link technique, the transmission latency varies, the parallel computer system 1a can appropriately synchronize the processes executed by the CPUs 10c to 10e and 18c to 18e.

Furthermore, even when the parallel computer system 1a has a component other than that illustrated in FIG. 7, the synchronization control mechanism 17c can appropriately synchronize the processes executed by the CPUs 10c to 10e and 18c to 18e. Specifically, when multiple CPUs that are connected to a single bus are used as a single group and when the CPU in which the synchronization control mechanism 17c is installed is connected to a CPU in a different group, the synchronization control mechanism 17c sends, to the CPU in the different group connected to the CPU that includes the synchronization control mechanism 17c itself, the control packet in which the synchronization request is stored.

Then, after the synchronization control mechanism 17c sends the control packet to the CPUs in each group, the synchronization control mechanism 17c then broadcasts the control packet to the group to which the CPU that includes the synchronization control mechanism 17c itself belongs. As described above, by sending a control packet to each of the CPUs 10c to 10e and 18c to 18e in multiple stages, the synchronization control mechanism 17c can appropriately synchronize the processes executed by the CPUs.

### [c] Third Embodiment

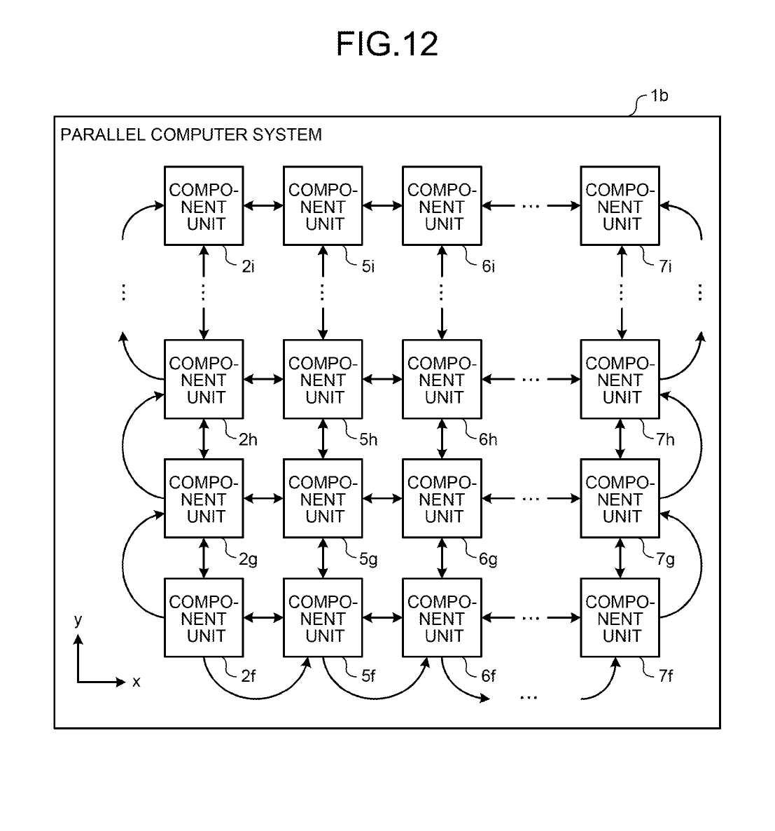

In a third embodiment, an example of a parallel computer system 1b will be described with reference to multiple drawings. FIG. 12 is a schematic diagram illustrating an example of a parallel computer system according to a third embodiment. As illustrated in FIG. 12, The parallel computer system 1b is a system in which multiple component units 2f to 2i, 5f to 5i, 6f to 6i, and 7f to 7i are connected in a two-dimensional mesh form in the x-axis direction and the y-axis direction.

Specifically, the component units 2f to 7f, 2g to 7g, 2h to 7h, and 2i to 7i are connected in the x-axis direction and the component units 2f to 2i, 5f to 5i, 6f to 6i, and 7f to 7i are connected in the y-axis direction. Although not illustrated in FIG. 12, the parallel computer system 1b further includes multiple component units that are connected in a mesh form. In the following, the process executed by the component unit 2f will be described. It is assumed that the other component units 2g to 2i, 5f to 5i, 6f to 6i, and 7f to 7i execute the same process as that executed by the component unit 2f; therefore, descriptions thereof will be omitted.

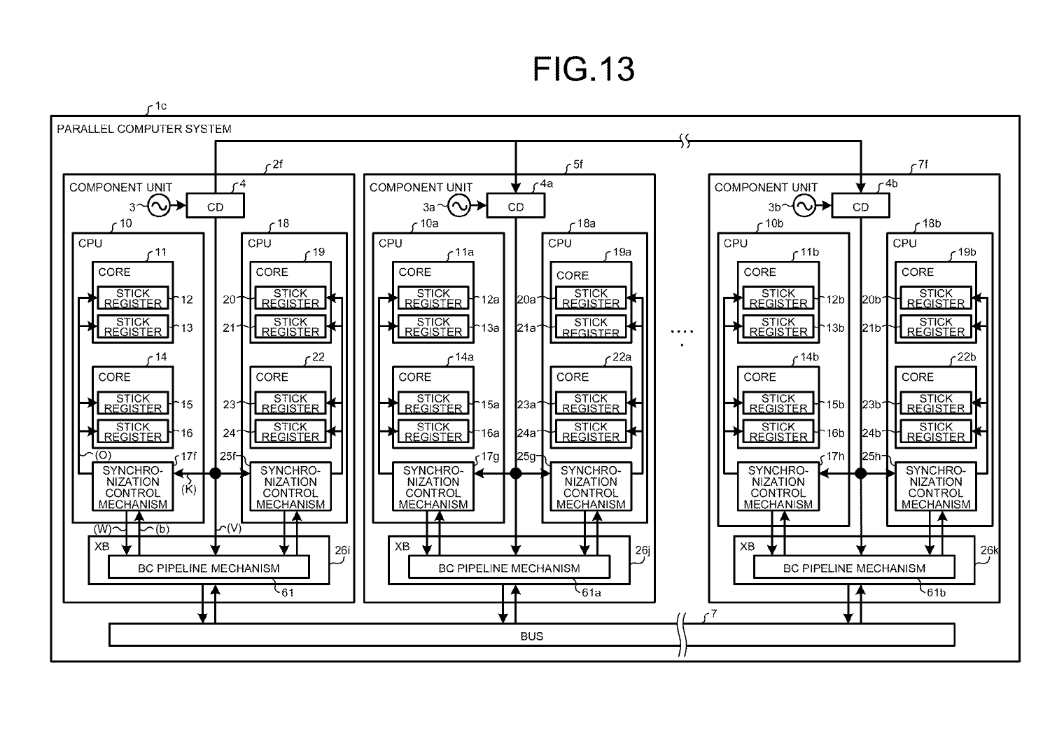

FIG. 13 is a schematic diagram illustrating a part of the parallel computer system according to the third embodiment. FIG. 13 illustrates components included in the component units 2f, 5f, and 7f that are connected in the x-axis direction. Furthermore, components having the same functions as those performed by the components according to the first embodiment are assigned the same reference numerals; therefore, descriptions thereof will be omitted. The paths illustrated by (K) and (O) in FIG. 13 correspond to the paths illustrated by (K) and (O) in FIG. 1, respectively.

Similarly to the component unit 2 according to the first embodiment, the component unit 2f includes the oscillator 3, the CD 4, the CPU 10, the CPU 18, and an XB 26i. The XB 26i includes a broadcast (BC) pipeline mechanism 61. As illustrated by (V) in FIG. 13, the divided signals generated by the CD 4 are also supplied to the BC pipeline mechanism 61. Further, it is assumed that the component units 2g to 2i, 5f to 5i, 6f to 6i, and 7f to 7i are similarly configured as the component unit 2f. As illustrated in FIG. 13, for example, the component unit 5f includes synchronization control mechanisms 17g and 25g, and an XB 26j including a BC pipeline mechanism 61a. Similarly, the component unit 7f includes synchronization control mechanisms 17h and 25h, and an XB 26k including a BC pipeline mechanism 61b.

The synchronization control mechanism 17f executes the same process as that executed by the synchronization control mechanism 17 according to the first embodiment. Furthermore, the synchronization control mechanism 17f sends, to the BC pipeline mechanism 61, a control packet at the “XBC0 Timing” at which a predetermined time has elapsed since the rising edge of the divided signal. The BC pipeline mechanism 61 receives the control packet from the synchronization control mechanism 17f via the path illustrated by (W) in FIG. 13.

At this point, if the size of the parallel computer system 1b is greater than a certain size, there may sometimes be a case in which a control packet is not delivered to all of the CPUs in the component units 2f to 7i within the time period for which a predetermined elapsed time reaches the “REG-WR Timing” since the rising edge of the divided signal. Thus, when the BC pipeline mechanism 61 receives the control packet from the CPU 10, the BC pipeline mechanism 61 broadcasts the control packet to each of the component units 5f to 7f that are connected to the component unit 2f, in the x-axis direction, that includes the CPU 10.

Furthermore, when a predetermined time has elapsed since the BC pipeline mechanism 61 broadcasts the control packet to each of the component units 2f and 5f to 7f in the x-axis direction or when the BC pipeline mechanism 61 receives a control packet that was sent one of the component units 5f to 7f, the BC pipeline mechanism 61 executes the following process. Namely, the BC pipeline mechanism 61 broadcasts the control packet to each of the component units 2g to 2e connected to the component unit 2b, in the y-axis direction, that includes the CPU 18.

Furthermore, when a predetermined time has elapsed since the BC pipeline mechanism 61 broadcasts the control packet to each of the component units 2g to 2e that is connected to the component unit 2f in the y-axis direction or when the BC pipeline mechanism 61 receives a control packet from one of the component units 2g to 2e, the BC pipeline mechanism 61 executes the following process. Namely, the BC pipeline mechanism 61 sends the received control packet to the synchronization control mechanism 17f via the path illustrated by (b) in FIG. 13. Furthermore, the BC pipeline mechanism 61 sends the control packet to the synchronization control mechanism 25. Thereafter, when the synchronization control mechanisms 17f or 25f receives the control packet from the BC pipeline mechanism 61, the synchronization control mechanisms 17f or 25f supplies the synchronization signal to each of the STICK registers at the “REG-WR Timing” indicated by the divided signal.

In the example described above, a description has been given with the assumption that the CPU 10 and 18 include the synchronization control mechanisms 17f and 25f and given with the assumption that the XB 26i includes the BC pipeline mechanism 61; however, the function performed by the BC pipeline mechanism 61 may also be integrated with the function performed by the synchronization control mechanism 17f. Furthermore, in addition to the XB 26i, the function performed by the BC pipeline mechanism 61 may also be provided in an arbitrary component.

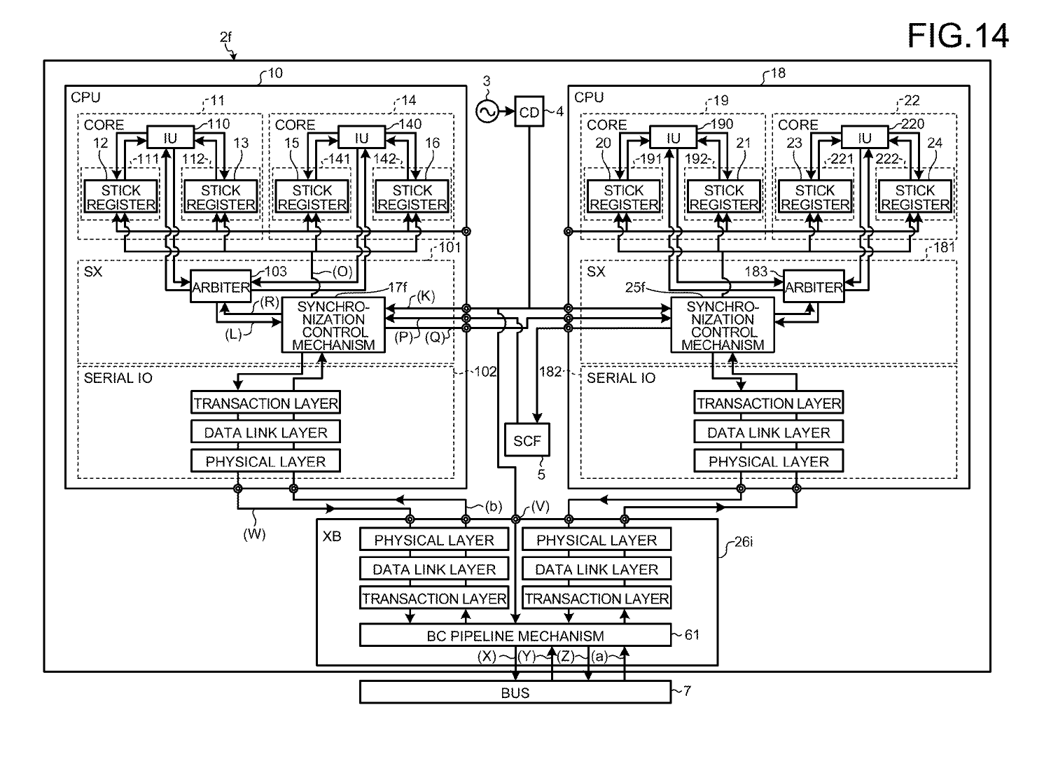

In the following, the position in which the BC pipeline mechanism 61 is installed will be described with reference to FIG. 14. FIG. 14 is a schematic diagram illustrating an example of components according to the third embodiment. Components illustrated in FIG. 14 having the same functions as those performed by the units illustrated in FIG. 2 are assigned the same reference numerals; therefore, descriptions thereof will be omitted. The paths illustrated by (K), (O), (V), (W), and (b) in FIG. 14 correspond to the paths illustrated by (K), (O), (V), (W), and (b), respectively, in FIG. 13. In the example illustrated in FIG. 14, the paths illustrated by (K), (L), and (O) to (R) in FIG. 14 correspond to the paths illustrated by (K), (L), and (O) to (R), respectively, in FIG. 2.

Specifically, it is assumed that the synchronization control mechanism 17f sends and receives the same signal via the paths illustrated by (K), (L), and (O) to (R) in FIG. 14 as those used by the synchronization control mechanism 17 according to the first embodiment; therefore, descriptions thereof will be omitted. Furthermore, the control packet that is sent by the synchronization control mechanism 17f at the “XBC0 Timing” is input to the BC pipeline mechanism 61 via the path illustrated by (W) in FIG. 14. Specifically, the “XBC0 Timing” is the timing at which the synchronization control mechanism 17f stores a control packet in the BC pipeline mechanism 61.

The BC pipeline mechanism 61 acquires a divided signal from the CD 4 via the path illustrated by (V) FIG. 14 in FIG. 14 and executes the same process as that executed by the synchronization control mechanism 17 according to the first embodiment, whereby the BC pipeline mechanism 61 measures the time period that has elapsed since the rising edge of the divided signal. Furthermore the BC pipeline mechanism 61 receives, via the path illustrated by (W) in FIG. 14, a control packet that is sent by the synchronization control mechanism 17f at the “XBC0 Timing”.

When the BC pipeline mechanism 61 receives the control packet from the synchronization control mechanism 17f and when a predetermined time that has elapsed since the rising edge of the divided signal reaches the “XBC1 Timing”, the BC pipeline mechanism 61 executes the following process. Namely, the BC pipeline mechanism 61 broadcasts the received control packet to the component units 2f and 5f to 7f via the path illustrated by (X) in FIG. 14. Specifically, the “XBC1 Timing” mentioned here is the timing at which a control packet is sent to the component units that are connected in the x-axis direction.

Furthermore, the BC pipeline mechanism 61 receives, via the path illustrated by (Y) in FIG. 14, the control packet that was broadcast to the component units 2f and 5f to 7f. In such a case, when the time reaches the “XBC2 Timing” at which a predetermined time period has elapsed since the rising edge of the divided signal, the BC pipeline mechanism 61 executes the following process. Namely, the BC pipeline mechanism 61 broadcasts, via the path illustrated by (Z) in FIG. 14, the control packet to each of the component units 2f to 2i connected in the y-axis direction. Specifically, the “XBC2 Timing” mentioned here is the timing at which the control packet is sent to the component units that are connected in the y-axis direction.

Furthermore, when the BC pipeline mechanism 61 receives, via the path illustrated by (a) in FIG. 14, the control packet that was broadcast to each of the component units 2f to 2i, the BC pipeline mechanism 61 executes the following process. Specifically, when the timing reaches the “SBC Timing” at which a predetermined time period has elapsed since the rising edge of the divided signal, the BC pipeline mechanism 61 sends the control packet to the synchronization control mechanism 17f via the path illustrated by (b) in FIG. 14. More specifically, the “SBC Timing” is the timing at which the control packet is sent to the synchronization control mechanism 17f.

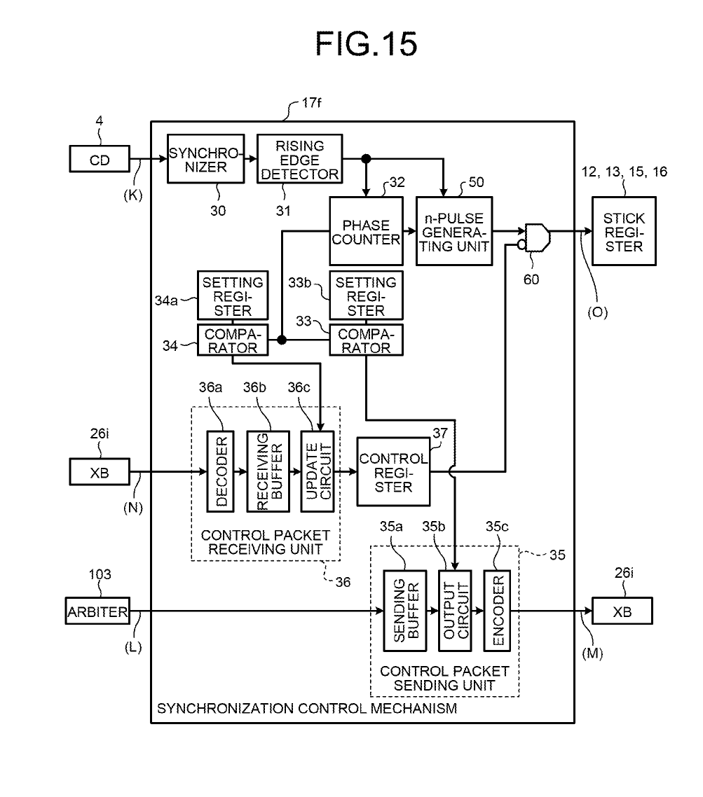

In the following, the synchronization control mechanism 17f according to the third embodiment will be described with reference to FIG. 15. FIG. 15 is a schematic diagram illustrating a synchronization control mechanism according to the third embodiment. Furthermore, components illustrated in FIG. 15 having the same function as those executed by the FIG. 3 are assigned the same reference numerals; therefore, descriptions thereof will be omitted.

The setting register 33b is a register that is used to set the “XBC0 Timing”. Specifically, the setting register 33b stores therein a value that indicates, in cycle units of the core clock, the time period between the rising edge of a divided signal and the “XBC0 Timing”. More specifically, the synchronization control mechanism 17f sends the control packet to the BC pipeline mechanism 61 in the XB 26i at the “XBC0 Timing” instead of the “XBC Timing”. When the synchronization control mechanism 17f receives a control packet from the BC pipeline mechanism 61 in the XB 26i, the synchronization control mechanism 17f starts, similarly to the synchronization control mechanism 17, to supply a control signal to each of the STICK registers 12, 13, 15, and 16 at the “REG-WR Timing”.

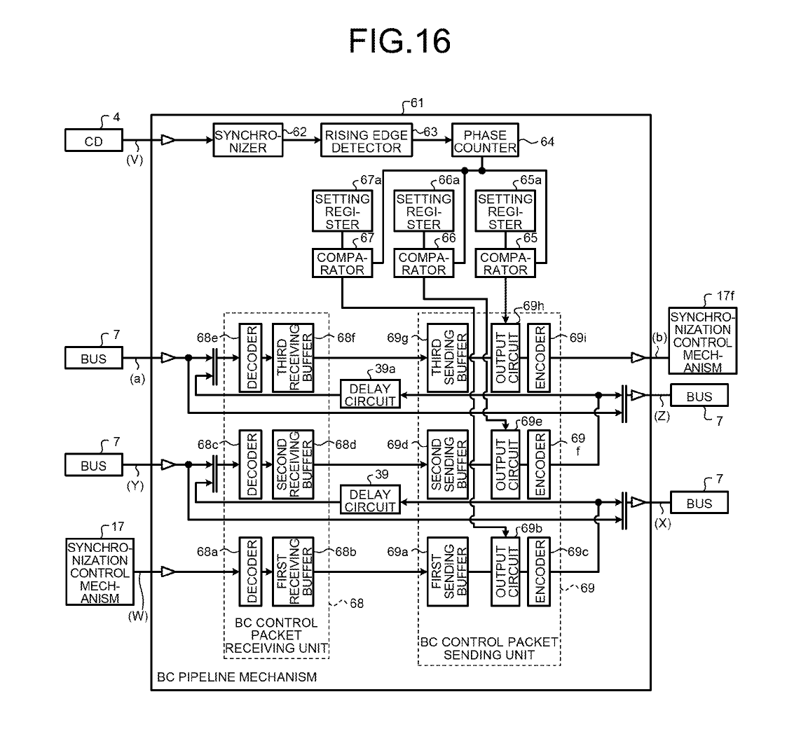

In the following, the process executed by the BC pipeline mechanism 61 will be described with reference to FIG. 16. FIG. 16 is a schematic diagram illustrating a BC pipeline mechanism according to the third embodiment. It is assumed that the paths illustrated by (X) to (Z), (a), and (b) in FIG. 16 correspond to the paths illustrated by (X) to (Z), (a), and (b) in FIG. 15, respectively.

In the example illustrated in FIG. 16, the BC pipeline mechanism 61 includes a synchronizer 62, a rising edge detector 63, a phase counter 64, comparators 65 to 67, setting registers 65a to 67a, a BC control packet receiving unit 68, and a BC control packet sending unit 69. The BC control packet receiving unit 68 includes multiple decoders 68a, 68c, and 68e, a first receiving buffer 68b, a second receiving buffer 68d, and a third receiving buffer 68f. The BC control packet sending unit 69 includes a first sending buffer 69a, a second sending buffer 69d, a third sending buffer 69g, multiple output circuits 69b, 69e, and 69h, and multiple encoders 69c, 69f, and 69i.

It is assumed that the synchronizer 62, the rising edge detector 63, and the phase counter 64 illustrated in FIG. 16 execute the same processes as those executed by the synchronizer 30, the rising edge detector 31, and the phase counter 32 illustrated in FIG. 3, respectively; therefore, descriptions thereof will be omitted. Furthermore, the setting register 65a stores therein a value that indicates the “XBC0 Timing” by using, in cycle units, the number of cycles of the core clock that are present since the rising edge of a divided signal.

Furthermore, the setting register 66a stores therein a value that indicates the “XBC1 Timing” by using, in cycle units, the number of cycles of the core clock that are present since the rising edge of a divided signal. Furthermore, the setting register 67a stores therein a value that indicates the “XBC2 Timing” by using, in cycle units, the number of cycles of the core clock that are present since the rising edge of the divided signal.

Furthermore, it is assumed that each of the decoders 68a, 68c, and 68e in the BC control packet receiving unit 68 executes the same function as that executed by the decoder 36a illustrated in FIG. 3; therefore, descriptions thereof will be omitted. Furthermore, the encoders 69c, 69f, and 69i in the BC control packet sending unit 69 execute the same function as that executed by the encoder 35c illustrated in FIG. 3; therefore, descriptions thereof will be omitted. The first receiving buffer 68b, the second receiving buffer 68d, and the third receiving buffer 68f are buffers that store therein a synchronization request that is acquired by the decoders 68a, 68c, and 68e, respectively, from a control packet.

The first sending buffer 69a, the second sending buffer 69d, and the third sending buffer 69g receive the control packet stored in the first receiving buffer 68b, the second receiving buffer 68d, and the third receiving buffer 68f, respectively, and then store the received packet. When the output circuit 69b receives a signal from the comparator 65, the output circuit 69b outputs the synchronization request that is stored in the first sending buffer 69a to the encoder 69c. When the output circuit 69e receives a signal from a comparator 66, the output circuit 69e stores, in the encoder 69f, the synchronization signal that is stored in the second sending buffer 69d. When the output circuit 69h receives a signal from the comparator 65, the output circuit 69h stores, in the encoder 69i, the synchronization signal that is stored in the third sending buffer 69g.

The BC pipeline mechanism 61 having such configuration receives a control packet from the synchronization control mechanism 17f via the path illustrated by (W) in FIG. 16. Then, the BC pipeline mechanism 61 decodes the control packet and acquires the synchronization request that is stored in the control packet. When the elapsed time from the rising edge of the divided signal reaches the “XBC1 Timing”, the BC pipeline mechanism 61 executes the following process. Namely, the BC pipeline mechanism 61 creates a control packet in which the synchronization request is stored and then broadcasts, via the path illustrated by (X) in FIG. 16, the control packet to the component units 2f and 5f to 7f that is connected in the x-axis direction. Furthermore, the BC pipeline mechanism 61 inputs the control packet to the delay circuit 39.

Furthermore, when the BC pipeline mechanism 61 receives, via the path illustrated by (Y) in FIG. 16, a control packet that was broadcast in the x-axis direction or when the delay circuit 39 outputs a control packet, the BC pipeline mechanism 61 executes the following process. Namely, the BC pipeline mechanism 61 acquires a synchronization request from the control packet and when the elapsed time since the rising edge of the divided signal reaches the “XBC2 Timing”, the BC pipeline mechanism 61 executes the following process. Namely, the BC pipeline mechanism 61 broadcasts, via the path illustrated by (Z) in FIG. 16, the control packet in which the synchronization request is stored to the component units 2f to 2i in the y-axis direction. Furthermore, the BC pipeline mechanism 61 inputs the control packet to a delay circuit 39a.

When the BC pipeline mechanism 61 receives the control packet that was broadcast, via the path illustrated by (a) in FIG. 16, to the component units 2f to 2i in the y-axis direction or when the delay circuit 39a outputs a control packet, the BC pipeline mechanism 61 executes the following process. Specifically, when the BC pipeline mechanism 61 acquires the synchronization request from the control packet and when the elapsed time since the rising edge of the divided signal reaches the “SBC Timing”, the BC pipeline mechanism 61 executes the following process. Namely, the BC pipeline mechanism 61 outputs the control packet in which the synchronization request is stored to the synchronization control mechanism 17f via the path illustrated by (b) in FIG. 16.

Thereafter, when the elapsed time since the rising edge of the divided signal reaches the “REG-WR Timing”, the synchronization control mechanism 17f that receives the synchronization request from the BC pipeline mechanism 61 outputs the synchronization signal created by an n-pulse generating unit 40 to each of the STICK registers.

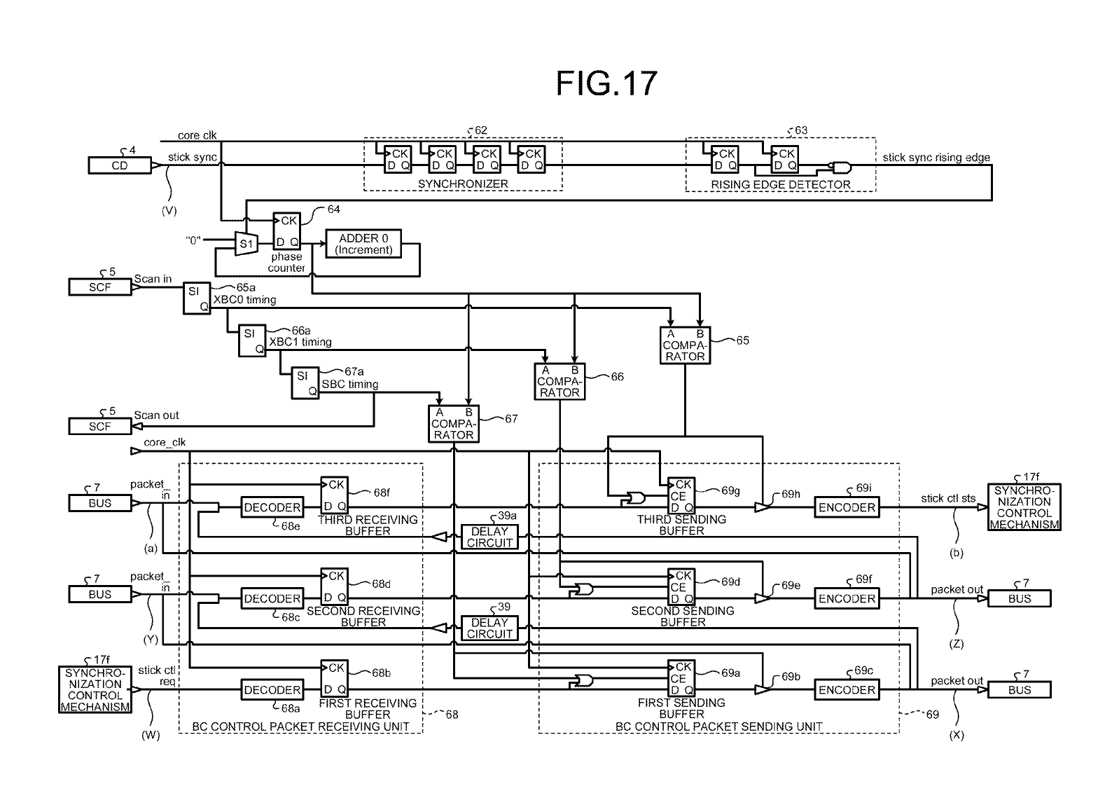

FIG. 17 is a schematic diagram illustrating an example of the BC pipeline mechanism. As illustrated in FIG. 17, the setting registers 65a, 66a, and 67a stores therein values that indicates the “XBC1 Timing”, the “XBC2 Timing”, and the “SBC Timing”, respectively, by using the Scan in signal.

The comparator 65 compares the value stored in the setting register 65a with the value of the phase counter 64. If the values match, the comparator 65 outputs a signal to the output circuit 69b that is a 3-state buffer. The comparator 66 compares the value stored in the setting register 66a with the value of the phase counter 64. If the values match, the comparator 66 outputs a signal to the output circuit 69e that is a 3-state buffer. The comparator 67 compares the value stored in the setting register 67a with the value of the phase counter 64. If the values match, the comparator 67 outputs a signal to the output circuit 69h that is a 3-state buffer. As described above, the BC pipeline mechanism 61 can be implemented by the components as those used in the synchronization control mechanism 17 illustrated in FIG. 5A at low cost and can also be easily packaged.

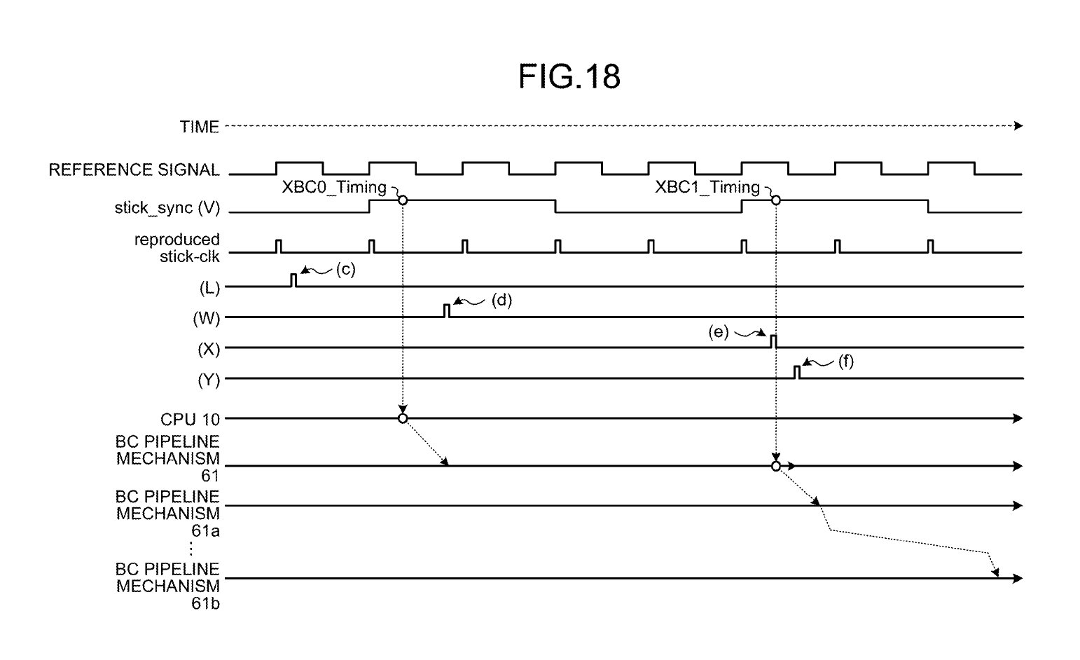

In the following, a description will be given of a process, with reference to FIGS. 18 to 20, that synchronizes CPUs included in the parallel computer system 1b. FIG. 18 is a timing chart illustrating the timing at which the synchronization control mechanism sends a control packet to the BC pipeline mechanism. FIG. 18 illustrates the reference signal, the stick_cync, the reproduced stick clk, the signal passing through the path illustrated by (L) in FIG. 15, the signals passing through the paths illustrated by (W), (X), and (Y) in FIG. 16. Furthermore, FIG. 18 illustrates the timing at which each of the BC pipeline mechanisms 61 to 61b receives a control packet. Furthermore, in the example illustrated in FIG. 18, it is assumed that the CPU 10 and the BC pipeline mechanisms 61 to 61b each receive a packet at the timing indicated by the dotted lines with the arrows. The waveforms of the signals received by the CPU 10 and the BC pipeline mechanisms 61 and 61b are simply illustrated.

In the example illustrated in FIG. 18, when the synchronization control mechanism 17f in the CPU 10 receives a synchronization request from an application at the timing illustrated by (C) in FIG. 18, the synchronization control mechanism 17f sends a control packet in which the synchronization request is stored to the BC pipeline mechanism 61 at the “XBC0 Timing”. Consequently, the BC pipeline mechanism 61 receives the control packet at the timing indicated by (d) in FIG. 18. Then, as illustrated by (e) in FIG. 18, when the elapsed time since the rising edge of the stick sync reaches the “XBC1 Timing”, the BC pipeline mechanism 61 executes the following process.

Namely, the BC pipeline mechanism 61 broadcasts a control packet to the BC pipeline mechanisms 61 to 61b in the component units 2f and 5f to 7f in the x-axis direction. Then, the BC pipeline mechanism 61 receives the control packet at the timing illustrated by (f) in FIG. 18.

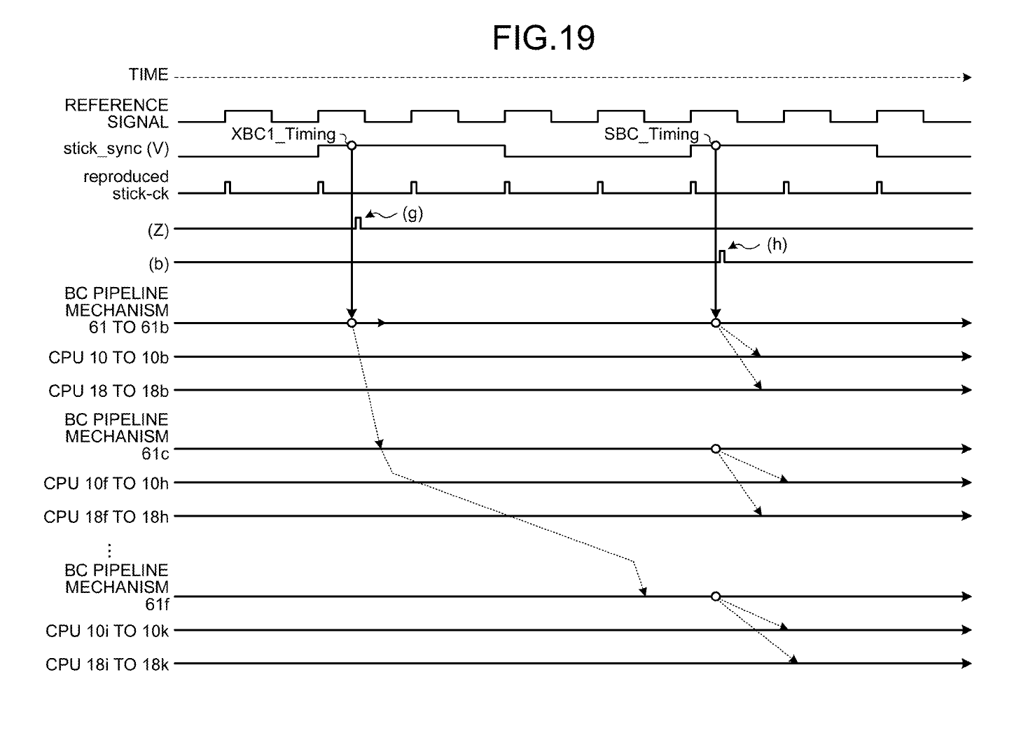

FIG. 19 is a timing chart illustrating the timing at which the BC pipeline mechanism broadcasts the control packet. FIG. 19 illustrates examples of the reference signal, the stick sync acquired from the path illustrated by (V) in FIG. 16, the reproduced stick clk, the signal passing through the path illustrated by (Z) in FIG. 16, and the signal passing through the path illustrated by (a) in FIG. 16. Furthermore, FIG. 19 illustrates examples of the timings at which the BC pipeline mechanisms 61 to 61b, the CPUs 10 to 10b, and the CPUs 18 to 18b each receive a control packet.

Furthermore, FIG. 19 illustrates examples of the timings at which the BC pipeline mechanism 61c in the component unit 2g and the CPUs 10f to 10h and the CPUs 18f to 18h in the component unit 2g each receive a control packet. Furthermore, FIG. 19 illustrates examples of the timings at which the BC pipeline mechanism 61f in the component unit 7i and the CPUs 10i to 10k and the CPUs 18i and 18k each receive a control packet. Furthermore, in the example illustrated in FIG. 19, it is assumed that each of the CPUs 10 to 10k and the BC pipeline mechanisms 61 to 61f receives a packet at the timing illustrated by the dotted lines with the arrows. The waveforms of the signals received by the CPUs 10 to 10k and the BC pipeline mechanisms 61 to 61f are simply illustrated.

In the example illustrated in FIG. 19, when the elapsed time since the rising edge of the divided signal reaches the “XBC2 Timing”, the BC pipeline mechanisms 61 to 61b sends, as illustrated by (G) in FIG. 19 via the path illustrated by (Z) in FIG. 16, the control packet to the component units in the y-axis direction. Consequently, the control packet is delivered to all of the component units 2f to 2i and 5f to 7i in the parallel computer system 1b. Then, the BC pipeline mechanisms 61 to 61f send, as illustrated by (h) in FIG. 19, the control packet to the CPUs 10 to 10k and 18 to 18k in the component units 2f to 2i and 5f to 7i, respectively, via the path illustrated by (b) in FIG. 16 at the “SBC Timing”.

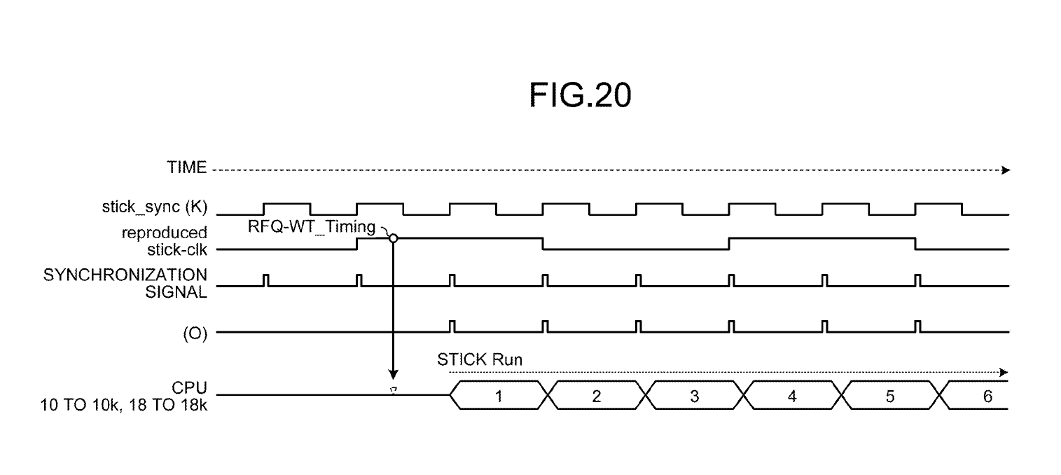

FIG. 20 is a timing chart illustrating the timing at which the synchronization control mechanism outputs a synchronization signal to a STICK register. FIG. 20 illustrates the reference signal, the stick sync acquired from the path illustrated by (K) in FIG. 15, the reproduced stick slk that is to be created, and the stick slk that is output from the path illustrated by (O) in FIG. 15. Furthermore, FIG. 20 illustrates the values stored in the STICK register in each of the CPUs 10 to 10k and 18 to 18k. In the example illustrated in FIG. 20, it is assumed that each of the CPUs 10 to 10k and 18 to 18k has already received a control packet.

As illustrated in FIG. 20, each of the synchronization control mechanism in the parallel computer system 1b stores, in the control register 37, a synchronization request that is stored in the control packet at the “REG-WR Timing”. Thus, each of the CPUs 10 to 10k and 18 to 18k simultaneously starts to input the reproduced stick clk to the corresponding STICK register. This makes it possible to make the values that are input to the STICK registers the same. Consequently, the parallel computer system 1b can synchronize the processes executed by the CPUs 10 to 10k and 18 to 18k.

As described above, the synchronization control mechanism 17f and the BC pipeline mechanism 61 broadcast a synchronization request to the component units 5f to 7f that are connected to the component unit 2f in the x-axis direction and then broadcast the synchronization request to the component units 2g to 2i that are connected in the y-axis direction. Then, when the synchronization control mechanism 17f receives the broadcast synchronization request and when a divided signal indicates the “REG-WR Timing” at which a STICK register is updated, the synchronization control mechanism 17f starts to output the synchronization signal to the STICK register in each of the CPUs 10 to 10b and 18 to 18b. Consequently, the parallel computer system 1b can appropriately synchronize the processes executed by the CPUs 10 to 10k and 18 to 18k.

Specifically, when the parallel computer system 1b is not able to broadcast, due to a large number of CPUs to be synchronized, the synchronization signal to each of the CPUs within a time period shorter than the cycle of the “REG-WR Timing” that is indicated by the divided signal, the parallel computer system 1b gradually sends the synchronization request to each of the CPUs. When the synchronization request has been delivered to each of the CPUs and when the timing reaches the “REG-WR Timing” indicated by the divided signal, the parallel computer system 1b synchronizes the processes executed by the CPUs. Consequently, even if the parallel computer system 1b is not able to broadcast the synchronization signal to the CPUs within a time period shorter than the cycle of the “REG-WR Timing” that is indicated by the divided signal, the parallel computer system 1b can appropriately synchronize the processes executed by the CPUs.

Furthermore, the synchronization control mechanism 17f starts to output a synchronization signal in accordance with the timing indicated by the divided signal that has a longer cycle than that of the reference signal. Consequently, even when the CPUs 10 to 10k and 18 to 18k are connected by way of a method in which transmission latency is not constant, such as a serial link, the parallel computer system 1b can synchronize the processes executed by the CPUs 10 to 10k and 18 to 18k.

### [d] Fourth Embodiment

In the above explanation, a description has been given of the embodiments according to the present invention; however, the embodiments are not limited thereto and can be implemented with various kinds of embodiments other than the embodiment described above. Therefore, another embodiment will be described as a fourth embodiment below.

(1) Component Unit Included in the Parallel Computer System

The parallel computer system 1 described above includes the component units 2 to 2b that are connected by a serial bus. Furthermore, the parallel computer system 1a includes the component units 2c to 5e that are connected by serial buses; however, the embodiment is not limited thereto. For example, the parallel computer system 1 and the parallel computer system 1a may also include an arbitrary number of component units.

Furthermore, each of the component units 2c to 2e includes two CPUs; however, the embodiment is not limited thereto. For example, each of the component units 2c to 2e may also include an arbitrary number of CPUs. In such a case, the synchronization control mechanism 17c sends a synchronization request to each of the CPUs in the same component unit that includes the CPU 10c and then sends the synchronization request to the other CPUs included in the component units 2c to 2e via a bus to which the other CPUs are connected.

Furthermore, the parallel computer system 1b includes multiple component units 2f to 2i and 5f to 7i that include two CPUs and that are connected, in a mesh form, in the x-axis direction and the y-axis direction; however, the embodiment is not limited thereto. For example, the parallel computer system 1b may also include multiple component units that are three-dimensionally connected in the x-axis direction, the y-axis direction, and the Z-axis direction. In such a case in which multiple component units are included, the synchronization control mechanisms and XBs execute the following process. Namely, the synchronization control mechanisms and XBs send, in multiple stages, a synchronization request to the component units in each of the directions. When the synchronization request is sent to all of the component units, the synchronization control mechanisms and XBs output a synchronization signal to the STICK counter included in each of the CPUs in accordance with the timing indicated by the divided signal.

Furthermore, the parallel computer system 1b may also include the component units 2f to 2i and 5f to 7i each of which includes an arbitrary number of the CPUs. For example, the parallel computer system 1b may also include the component units 2f to 2i and 5f to 7i each of which includes a single CPU. Specifically, the parallel computer system 1b may also include multiple CPUs that are connected in the x-axis direction and the y-axis direction. In such a case, each of the synchronization control mechanisms sends a synchronization request to the CPUs that are connected in the x-axis direction and then sends the synchronization request to the CPUs that are connected in the y-axis direction. Then, each of the synchronization control mechanisms outputs, at the timing indicated by a divided signal, the synchronization signal to the STICK register included in each of the CPUs.

As described above, the parallel computer system sends a synchronization request to the synchronization control apparatus in each CPU that includes the subject synchronization control apparatus and then allows each of the CPUs to start the process at the timing that is indicated by a divided signal. Consequently, even when the CPUs are connected by way of a method in which the transmission latency varies, such as a serial link, the parallel computer system can appropriately synchronize the processes executed by the CPUs.

(2) Destination of a Synchronization Request

The parallel computer system 1b described above broadcasts a synchronization request to the component units that are connected in the x-axis direction and then broadcasts the synchronization request to the component units that are connected in the y-axis direction; however, embodiments are not limited thereto. For example, instead of sending the synchronization request to the component units that are connected in each of the directions at a time, the parallel computer system 1b may also execute the process, in multiple stages, that sends the synchronization request to the component units.

Specifically, the parallel computer system sends, by using an arbitrary method, a synchronization request to each of the CPUs and then starts to synchronize the processes executed by the CPUs on the basis of the timing indicated by the divided signal that has a longer cycle than that of the reference signal. Furthermore, in the parallel computer system, for the path through which the synchronization request is sent to each of the CPUs, it is possible to design an appropriate path in accordance with various conditions, such as the size of the system or the latency of the transmission path.

According to an aspect of an embodiment of the present invention, an advantage is provided in that synchronization control can be executed when CPUs are connected by way of a method in which the transmission latency is not constant, such as a serial link.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A synchronization control apparatus that is connected to a clock divider, which divides an input clock signal into N, and that is included in an arithmetic processing device that is connected to another arithmetic processing device via a data transfer device, the synchronization control apparatus comprising:
a detecting unit that detects the rising or the falling of a divided clock signal that is divided by the clock divider;
a monitoring unit that monitors, by monitoring the elapsed time since the rising or the falling of the divided clock signal detected by the detecting unit, a first timing at which a synchronization request is sent to the data transfer device and a second timing at which a synchronization register included in the arithmetic processing device is updated;
a clock generating unit that generates a control clock by multiplying the divided clock signal, which is divided by the clock divider, by N;
a synchronization request receiving unit that receives, via the data transfer device, a synchronization request sent from the other arithmetic processing device;
a clock control unit that outputs, when the synchronization request receiving unit receives the synchronization request sent from the other arithmetic processing device and when the monitoring unit detects the second timing, the control clock generated by the clock generating unit; and
a synchronization request sending unit that sends, when the monitoring unit detects the first timing, a synchronization request to the other arithmetic processing device via the data transfer device.

2. The synchronization control apparatus according to claim 1, wherein
the monitoring unit further monitors a cycle of the divided clock signal, and
the clock generating unit includes
a first cycle retaining circuit that retains the cycle of the divided clock signal detected by the monitoring unit,
a second cycle retaining circuit that retains 1/N of the cycle of the divided clock signal,
a dividing circuit that divides the cycle of the divided clock signal retained in the first cycle retaining circuit by N and that retains, in the second cycle retaining circuit, 1/N of the cycle of the divided clock signal,
a first counting circuit that decrements a retained value by one starting from N,
an N-detecting circuit that detects that the value retained in the first counting circuit is other than zero,
a second counting circuit that increments, on the basis of the cycle that is 1/N of the cycle of the divided clock signal, by one starting from zero,
a zero-detecting circuit that detects that the value retained in the second counting circuit is zero, and
an AND circuit that outputs the logical conjunction of the zero-detecting circuit and the N-detecting circuit.

3. The synchronization control apparatus according to claim 1, wherein
the monitoring unit includes
an elapsed time monitoring unit that monitors the elapsed time since the rising or the falling of the divided clock signal detected by the detecting unit,
a first setting register that stores therein a time value that is used to detect the first timing,
a second setting register that stores therein a time value that is used to detect the second timing, and
a timing detecting unit that notifies, when the value stored in the first setting register matches the time monitored by the elapsed time monitoring unit, the synchronization request sending unit of the detection of the first timing and that notifies, when the value stored in the second setting register matches the time monitored by the elapsed time monitoring unit, the clock control unit of the detection of the second timing.

4. The synchronization control apparatus according to claim 1, wherein
the monitoring unit further monitors a third timing at which a synchronization request is sent to another arithmetic processing device that is associated with the arithmetic processing device and that is connected to a path different from a path to which the arithmetic processing device is connected,
when the monitoring unit detects the third timing, the synchronization request sending unit sends a synchronization request to the other arithmetic processing device, and
when a predetermined time period has elapsed since the sending of the synchronization request and when the monitoring unit detects the first timing, or when a synchronization request is received from the other arithmetic processing device and when the monitoring unit detects the first timing, the synchronization request sending unit sends the synchronization request to the other arithmetic processing device via the data transfer device.

5. The synchronization control apparatus according to claim 1, wherein
when multiple arithmetic processing devices are connected, in a two-dimensional mesh form, in the x-axis direction and in the y-axis direction, the monitoring unit further monitors a fourth timing at which a synchronization request is sent to the arithmetic processing devices that are connected in the x-axis direction and monitors a fifth timing at which a synchronization request is sent to the arithmetic processing devices that are connected in the y-axis direction,
when the monitoring unit detects the fourth timing, the synchronization request sending unit sends a synchronization request to the arithmetic processing devices that are connected in the x-axis direction,
when a predetermined time period has elapsed since the synchronization request is sent and when the monitoring unit detects the fifth timing, or when a synchronization request is received from one of the arithmetic processing devices that are connected in the x-axis direction and when the monitoring unit detects the fifth timing, the synchronization request sending unit sends, via the data transfer device, the synchronization request to the arithmetic processing devices that are connected in the y-axis direction, and
when a predetermined time period has elapsed since the synchronization request wending unit sends a synchronization request to the arithmetic processing devices that are connected in the y-axis direction and when the monitoring unit detects the second timing, or when a synchronization request is received from one of the arithmetic processing devices that are connected in the y-axis direction and when the monitoring unit detects the second timing, the clock control unit outputs the control clock generated by the clock generating unit.

6. The synchronization control apparatus according to claim 5, wherein
component units each of which includes the multiple arithmetic processing devices are connected, in a two-dimensional mesh form, in the x-axis direction and the y-axis direction,
when the monitoring unit detects the fourth timing, the synchronization request sending unit sends a synchronization request to the component units that are connected in the x-axis direction,
when a predetermined time period has elapsed since the synchronization request is sent and when the monitoring unit detects the fifth timing, or when a synchronization request is received from one of the component units that are connected in the x-axis direction and when the monitoring unit detects the fifth timing, the synchronization request sending unit sends, via the data transfer device, the synchronization request to the component units that are connected in the y-axis direction, and
when a predetermined time period has elapsed since the synchronization request sending unit sends a synchronization request to the component units that are connected in the y-axis direction and the monitoring unit detects the second timing, or when a synchronization request is received from one of the component units that are connected in the y-axis direction and when the monitoring unit detects the second timing, the clock control unit outputs the control clock generated by the clock generating unit.

7. An arithmetic processing device that is connected to another arithmetic processing device via a data transfer device, the arithmetic processing device comprising:
an arithmetic processing unit that executes arithmetic processing; and
a synchronization control apparatus that receives an input of a divided clock signal, which is generated by a clock divider by dividing an input clock signal into N, and that executes synchronization control between the arithmetic processing device and the other arithmetic processing device, wherein
the synchronization control apparatus includes
a detecting unit that detects the rising or the falling of the divided clock signal to be input,
a monitoring unit that monitors, by monitoring the elapsed time since the rising or the falling of the divided clock signal detected by the detecting unit, a first timing at which a synchronization request is sent and a second timing at which a synchronization register included in the arithmetic processing device is updated,
a clock generating unit that generates a control clock by multiplying the divided clock signal, which is divided by the clock divider, by N,
a synchronization request receiving unit that receives, via the data transfer device, a synchronization request sent from the other arithmetic processing device,
a clock control unit that, when the synchronization request receiving unit receives the synchronization request from the other arithmetic processing device and when the monitoring unit detects the second timing, updates the synchronization register and outputs the control clock generated by the clock generating unit to the arithmetic processing unit, and
a synchronization request sending unit that sends, when the monitoring unit detects the first timing, a synchronization request to the other arithmetic processing device via the data transfer device.

8. A parallel computer system comprising:
a clock divider that divides an input clock signal into N; and
multiple arithmetic processing devices each of which is connected to one of the arithmetic processing devices via a data transfer device, wherein
each of the arithmetic processing devices includes a synchronization control apparatus that executes a process in synchronization with the arithmetic processing devices, and
the synchronization control apparatus includes
a detecting unit that detects the rising or the falling of a divided clock signal that is divided by the clock divider,
a monitoring unit that monitors, by monitoring the elapsed time since the rising or the falling of the divided clock signal detected by the detecting unit, a first timing at which a synchronization request is sent to the data transfer device and a second timing at which a synchronization register included in each of the arithmetic processing devices is updated,
a clock generating unit that generates a control clock by multiplying the divided clock signal, which is divided by the clock divider, by N,
a synchronization request receiving unit that receives, via the data transfer device, a synchronization request sent from the one of the arithmetic processing devices,
a clock control unit that outputs, when the synchronization request receiving unit receives the synchronization request sent from the one of the arithmetic processing devices and when the monitoring unit detects the second timing, the control clock generated by the clock generating unit, and
a synchronization request sending unit that sends, when the monitoring unit detects the first timing, the synchronization request to the arithmetic processing devices via the data transfer device.

9. A control method executed by a synchronization control apparatus that is connected to a clock divider, which divides an input clock signal into N, and that is included in an arithmetic processing device that is connected to another arithmetic processing device via a data transfer device, the control method comprising:
detecting the rising or the falling of a divided clock signal divided by the clock divider;
monitoring, by monitoring the elapsed time since the rising or the falling of the divided clock signal detected at the detecting, a first timing at which a synchronization request is sent to the data transfer device and a second timing at which a synchronization register included in the arithmetic processing device is updated;
generating a control clock by multiplying the divided clock signal by N;
receiving, via the data transfer device, a synchronization request sent from the other arithmetic processing device;
outputting, when the synchronization request sent from the other arithmetic processing device is received and when the second timing is detected, the control clock generated at the generating; and
sending, via the data transfer device, the synchronization request to the other arithmetic processing device when the first timing is detected.
